(19) United States
(12) Patent Application Publication
(10) Pub. No.: US 2025/0373024 A1
(43) Pub. Date: Dec. 4, 2025

(54) POWER CONVERSION DEVICE

(71) Applicant: SANSHA ELECTRIC MANUFACTURING CO., LTD., Osaka (JP)

(72) Inventor: Takehiro MIYAKE, Osaka (JP)

(73) Assignee: SANSHA ELECTRIC MANUFACTURING CO., LTD., Osaka (JP)

(21) Appl. No.: 19/221,162

(22) Filed: May 28, 2025

(30) Foreign Application Priority Data
May 29, 2024 (JP) 2024-087471

(51) Int. Cl. H02J 3/40; H02J 3/38; H02M 1/00; H02M 7/5387

(52) U.S. Cl. CPC H02J 3/40; H02M 1/0009; H02M 7/53873; H02J 3/381

(57) ABSTRACT

To provide a power conversion device capable of limiting active power and reactive power at different rations respectively. A current command value correction unit includes a command value transformation unit that transforms a d-axis current command value and a q-axis current command value having an internal phase into a first d-axis current command value and a first q-axis current command value having a grid phase, respectively, in consideration of a phase difference between the internal phase and a grid phase, a current limiting unit that is limited to at least one of the first d-axis current command value and the first q-axis current command value, and a command value inverse transformation unit that inversely transforms a third d-axis current command value and a third q-axis current command value having the grid phase after the limitation into a corrected d-axis current command value and the corrected q-axis current command value having the internal phase, respectively.

### BACKGROUND OF THE INVENTION

### 1. Technical Field

The present invention relates to a power conversion device.

### 2. Description of the Related Art

There is a power supply system in which distributed power sources such as a solar power generator, a fuel cell power generator, a wind power generator, and a storage battery device are connected to a grid via an inverter. Since many of such distributed power sources do not have an inertial force or the like, the inertial force or the like of the power supply system may decrease. Thus, a virtual synchronous generator that simulates an inertial force or the like of a synchronous generator to an inverter (power converter) has been widely used. The virtual synchronous generator includes a current control type virtual synchronous generator. The current control type virtual synchronous generator simulates a synchronous generator by controlling the current using a current command value. This can prevent the current output from the power conversion device from becoming an overcurrent and can protect the power conversion device.

JP 2021-141704 A discloses an inverter control system including a dq absolute value limiting unit. The dq absolute value limiting unit limits a current command value (limits the current command value). By limiting the current command value to a desired magnitude, the device can be operated with stable grid voltage. Specifically, in JP 2021-141704 A, active power and reactive power are limited at the same ratio by limiting the current command value with a dq absolute value limit, which prevents the current output from a power conversion device from becoming an overcurrent.

### SUMMARY OF THE INVENTION

In JP 2021-141704 A, the active power and the reactive power are limited at the same ratio. However, there is a difference that the active power mainly affects the grid frequency, and the reactive power mainly affects the grid voltage. Thus, it is sometimes desired to limit the active power and the reactive power at different ratios respectively in consideration of the state of the grid, the purpose of controlling the grid, the energy storage remaining amount on the DC side, the magnitude of the DC voltage, and the like.

A main object of the present invention is to provide a power conversion device capable of limiting the active power and the reactive power at different ratios respectively.

A power conversion device according to the present invention includes:
an inverter that converts DC power of a DC power source into AC power and outputs the AC power to a grid via an output line; and
an inverter controller that controls the inverter to perform virtual synchronous generator control with a virtual synchronous generator simulating a synchronous generator.

The inverter controller includes:
a dq transformation unit that derives a d-axis current, a d-axis voltage, a q-axis current, and a q-axis voltage on an internal-phase-synchronized dq coordinate system that rotates in synchronization with an internal phase of the virtual synchronous generator from an output voltage and an output current measured on the output line of the inverter, the d-axis current, the d-axis voltage, the q-axis current, and the q-axis voltage having the internal phase;
an internal phase derivation unit that derives an internal frequency deviation of the virtual synchronous generator from a deviation between active power derived from the d-axis current, the d-axis voltage, the q-axis current, and the q-axis voltage and an active power command value input from outside to the inverter controller, and derives the internal phase from the internal frequency deviation and an external frequency command value input from the outside to the inverter controller;
an AVR unit that derives an internal voltage of the virtual synchronous generator from reactive power derived from the d-axis current, the d-axis voltage, the q-axis current, and the q-axis voltage, a reactive power command value input from the outside to the inverter controller, an output voltage absolute value derived from the d-axis voltage and the q-axis voltage, and an external voltage command value input from the outside to the inverter controller, to perform automatic voltage control in the virtual synchronous generator;
a current command value derivation unit that derives a d-axis current command value having the internal phase and a q-axis current command value having the internal phase from the internal voltage, the d-axis voltage, the q-axis voltage, and an internal impedance of the virtual synchronous generator;
a current command value correction unit that transforms the d-axis current command value and the q-axis current command value into a first d-axis current command value and a first q-axis current command value, respectively, in consideration of a phase difference between the internal phase and a grid phase of the grid, and then derives a corrected d-axis current command value and a corrected q-axis current command value by using a value obtained by limiting at least one of the first d-axis current command value and the first q-axis current command value; and
a switching controller that derives a switching control signal for performing switching control on the inverter to output a current corresponding to each of the corrected d-axis current command value and the corrected q-axis current command value to the output line of the inverter.

The current command value correction unit includes:
a command value transformation unit that transforms the d-axis current command value having the internal phase and the q-axis current command value having the internal phase into the first d-axis current command value having the grid phase and the first q-axis current command value having the grid phase, respectively;
a current limiting unit that derives, using a d-axis current limit value and a q-axis current limit value input from the outside to the inverter controller to adjust each of the active power and the reactive power, the first d-axis current command value, and the first q-axis current command value, a second d-axis current command value having the grid phase by multiplying the first d-axis current command value by the d-axis current limit value and derives a second q-axis current command value having the grid phase by multiplying the first q-axis current command value by the q-axis current limit value, wherein the d-axis current limit value and the q-axis current limit value are different values of 0 or more; and
a command value inverse transformation unit that inversely transforms the second d-axis current command value having the grid phase and the second q-axis current command value having the grid phase into the corrected d-axis current command value having the internal phase and the corrected q-axis current command value having the internal phase, respectively.

The power conversion device according to the present invention can limit the active power and the reactive power at different ratios respectively.

According to the present invention, a power conversion device capable of limiting the active power and the reactive power at different ratios respectively can be provided.

The above-described object, other objects, features, and advantages of the present invention will further be made clear by the following description of embodiments of the invention, which description is made with reference to the drawings.

### BRIEF DESCRIPTION OF THE DRAWINGS

FIG. 1 is a configuration diagram of a power conversion system according to an embodiment of the present invention;

FIG. 2 is an explanatory diagram illustrating a current command value in an αβ coordinate system, an internal-phase-synchronized dq coordinate system, and a grid-phase-synchronized dq coordinate system;

FIG. 3 is a configuration diagram of a measurement value calculation unit in FIG. 1;

FIG. 4 is a configuration diagram of a power calculation unit in FIG. 3;

FIG. 5 is a configuration diagram of a control signal derivation unit in FIG. 1;

FIG. 6 is a configuration diagram of a current command value derivation unit in FIG. 5;

FIG. 7 is a configuration diagram of a current command value correction unit in FIG. 5;

FIG. 8 is a schematic diagram illustrating ranges of active power and reactive power on a grid-phase-synchronized dq coordinate system after a d-axis current command value and a q-axis current command value are multiplied by a current absolute value limit value;

FIG. 9 is a configuration diagram of the control signal derivation unit that does not perform correction on a d-axis current command value and a q-axis current command value in consideration of a phase difference between an internal phase and a grid phase;

FIG. 10 is a configuration diagram of a current command value correction unit in FIG. 9;

FIG. 11 is a schematic diagram illustrating ranges of active power and reactive power obtained by the control signal derivation unit in FIG. 9 on a grid-phase-synchronized dq coordinate system and ranges of active power and reactive power obtained by the control signal derivation unit according to the present embodiment on the grid-phase-synchronized dq coordinate system; and

FIG. 12 is a schematic diagram illustrating ranges of active power and reactive power obtained by the control signal derivation unit according to the present embodiment on a grid-phase-synchronized dq coordinate system.

### DETAILED DESCRIPTION

### 1. Power Conversion System

### (1) Overview of Power Conversion System

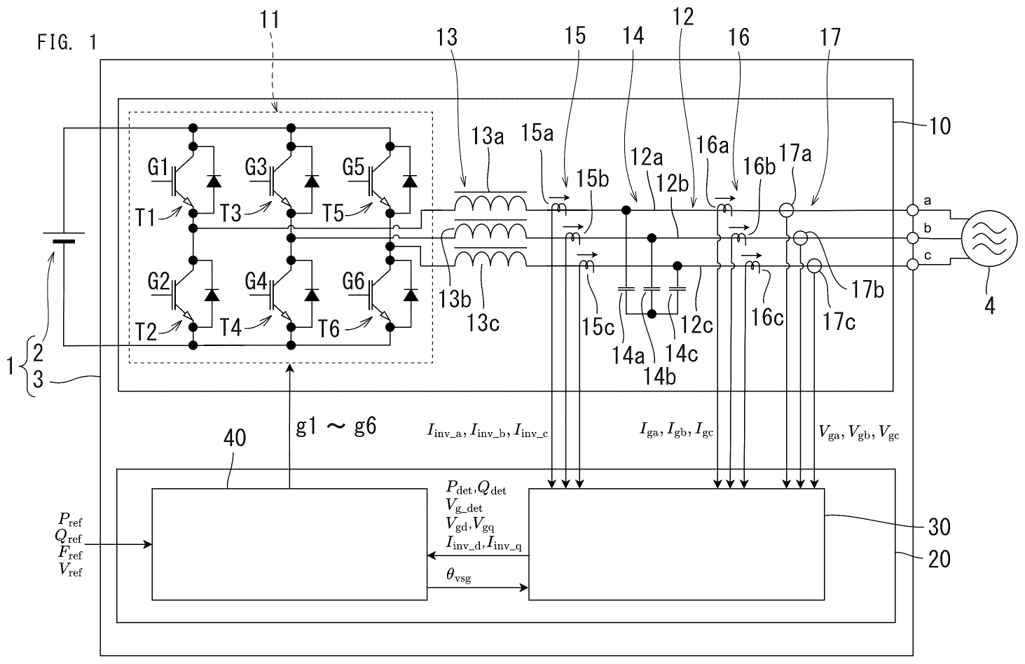

FIG. 1 is a configuration diagram of a power conversion system according to an embodiment of the present invention. A power conversion system 1 includes a DC power source 2 and a power conversion device 3. The power conversion system 1 is connected to a grid (so-called commercial power grid) 4 and controls power interchange between the DC power source 2 and the grid 4.

The DC power source 2 is, for example, a distributed power source such as a solar power generator, a fuel cell power generator, a wind power generator, a storage battery device, or a gas engine power generator. The power conversion device 3 is connected between the DC power source 2 and the grid 4.

The power conversion device 3 performs power conversion between DC power that is an output or input of the DC power source 2 and AC power that is an output or input of the grid 4. The power conversion device 3 is configured to be able to perform an interconnection operation in which the DC power source 2 and the grid 4 are operated in an interconnected manner, and a self-sustained operation in which the DC power source 2 is operated independently of the grid 4. In the interconnection operation, the power conversion device 3 operates to supply power to a load in a state where the power is interchanged between the DC power source 2 and the grid 4. In the self-sustained operation, the DC power source 2 is disconnected from the grid 4, and the power conversion device 3 operates so as to supply power from the DC power source 2 to a load.

The power conversion device 3 according to the present embodiment performs virtual synchronous generator control with a virtual synchronous generator that simulates the operation of a synchronous generator in the interconnection operation. In particular, the power conversion device 3 performs virtual synchronous generator control with a current control type virtual synchronous generator. Since inertia or the like of the synchronous generator is virtually simulated in the virtual synchronous generator control, the stability of the grid frequency and the grid voltage of the grid 4 can be improved. The power in the power conversion system 1 and the grid 4 includes active power and reactive power. In the present embodiment, by limiting the d-axis current command value and the q-axis current command value at different ratios respectively in the current control type virtual synchronous generator, the active power and the reactive power are limited at different ratios respectively. The power conversion device 3 ensures the stability of the grid frequency and the grid voltage in the grid 4 even in the case described above.

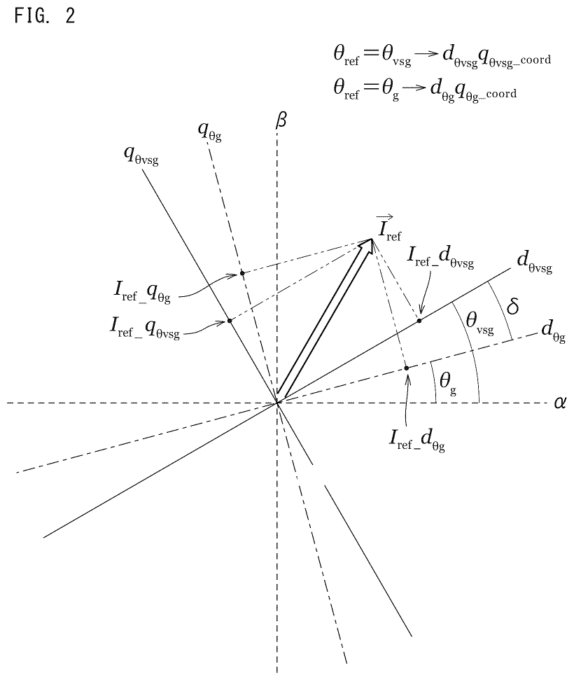

Here, in the current control type virtual synchronous generator control, the power conversion device 3 is controlled with an internal phase θvsg of the virtual synchronous generator (hereinafter, simply referred to as internal phase θvsg). On the other hand, the grid 4 has a grid phase θg of the grid 4 (hereinafter, simply referred to as grid phase θg). The internal phase θvsg may deviate from the grid phase θg. The deviation between the internal phase θvsg and the grid phase θg can be described as follows, for example. The synchronous generator and the virtual synchronous generator operate to move on a power-phase difference angle curve. The power-phase difference angle curve is a sinusoidal curve representing the relationship between the active power, the reactive power, and the phase difference angle when an internal voltage, an output voltage, and an internal impedance are given. The phase difference angle is a difference between the internal phase θvsg and the grid phase θg. According to the power-phase difference angle curve, depending on the values of the active power and the reactive power, the phase difference angle is typically a non-zero value. The fact that the phase difference angle has a non-zero value indicates that a deviation is generated between the internal phase θvsg and the grid phase θg. When the power conversion device 3 performs control so as to limit the active power and the reactive power at different ratios respectively in a state where the internal phase θvsg and the grid phase θg are shifted from each other like this, at least one of the active power and the reactive power in the grid 4 cannot be limited to a desired magnitude in some cases. This point will be further described below with reference to FIG. 2.

FIG. 2 is an explanatory diagram illustrating a current command value in an αβ coordinate system, an internal-phase-synchronized dq coordinate system, and a grid-phase-synchronized dq coordinate system. In the grid 4 in the present embodiment, an a-phase current, a b-phase current, a c-phase current, an a-phase voltage, a b-phase voltage, and a c-phase voltage of respective three phases (phase a, phase b, phase c) are used. The current and voltage of each of the three phases can be expressed in a three-phase coordinate system in which the a-axis, the b-axis, and the c-axis are shifted by 120°. The three-phase coordinate system is transformed with three-phase to two-phase transformation into a coordinate system in which the α axis and the β axis are orthogonal to each other, which are the αβ coordinate system illustrated in FIG. 2. In the αβ coordinate system, the direction of the vector of the current component (or the voltage component) changes with time.

The dq coordinate system is a coordinate system obtained by transforming an αβ coordinate system such that the direction of the vector of the current component (or the voltage component) does not change with time as the dq coordinate system itself rotates with time. Here, the current and the voltage in the virtual synchronous generator control have the internal phase θvsg. FIG. 2 illustrates a dq coordinate system (hereinafter, referred to as internal-phase-synchronized dq coordinate system (dθvsgqθvsg_coord in FIG. 2)) that rotates in synchronization with the internal phase θvsg. The internal-phase-synchronized dq coordinate system is an orthogonal coordinate system having a dθvsg axis and a qθvsg axis. In FIG. 2, an intersection of the dθvsg axis and the qθvsg axis coincides with an intersection of the α axis and the β axis. The internal-phase-synchronized dq coordinate system is shifted from the αβ coordinate system by the internal phase θvsg. In other words, the internal-phase-synchronized dq coordinate system is a coordinate system in which a reference phase θref to be described later is the internal phase θvsg (reference phase θref=internal phase θvsg). The internal phase θvsg changes with time, and the internal-phase-synchronized dq coordinate system rotates in synchronization with the internal phase θvsg.

On the other hand, the grid current and the grid voltage of the grid 4 have the grid phase θg. The grid phase θg and the internal phase θvsg may be shifted from each other. FIG. 2 illustrates a dq coordinate system (hereinafter, referred to as grid phase-synchronized dq coordinate system (dθgqθg_coord in FIG. 2) that rotates in synchronization with the grid phase θg. The grid-phase-synchronized dq coordinate system is an orthogonal coordinate system having a dog axis and a qθg axis. In FIG. 2, an intersection of the dog axis and the qθg axis coincides with an intersection of the dθvsg axis and the q θvsg axis and an intersection of the α axis and the β axis. The grid-phase-synchronized dq coordinate system is shifted from the αβ coordinate system by the grid phase θg. In other words, the grid-phase-synchronized dq coordinate system is a coordinate system in which the reference phase θref is the grid phase θg (reference phase θref=grid phase θg). The grid phase θg changes with time, and the grid-phase-synchronized dq coordinate system rotates in synchronization with the grid phase θg.

FIG. 2 illustrates a vector of a current command value Iref. In the internal-phase-synchronized dq coordinate system, the dθvsg axis component of the current command value Iref is Iref_dθvsg having an internal phase θvsg, and the qθvsg axis component of the current command value Iref is Iref_qθvsg having an internal phase θvsg. On the other hand, in the grid-phase-synchronized dq coordinate system, the deg-axis component of the current command value Iref is Iref_dθg having the grid phase θg, and the qθg-axis component of the current command value Iref is Iref_qθg having the grid phase θg. Thus, when the grid phase θg and the internal phase θvsg are shifted from each other, Iref_dθvsg and Iref_dθg have different values, and similarly, Iref_qθvsg and Iref_qθg have different values.

Normally, the power conversion device 3 applies a desired limit to each of Iref_dθvsg and Iref_qθvsg having the internal phase θvsg using a d-axis current limit value and a q-axis current limit value. As a result, I′ref_dθvsg and I′ref_qθvsg having the internal phase θvsg are calculated as the current command values after the limitation. The d-axis current limit value and the q-axis current limit value are limit values at different ratios respectively in the present embodiment, and they can be, for example, the d-axis current limit value=1.0 and the q-axis current limit value=0.5. Then, the power conversion device 3 supplies the active power and the reactive power based on I′ref_dθvsg and I′ref_qθvsg having the internal phase θvsg to the grid 4. However, the active power and the reactive power based on I′ref_dθvsg and I′ref_qθvsg having the internal phase θvsg are not limited to desired magnitudes based on a desired limit in the grid 4 in some cases. This is considered to be due to the deviation between the internal phase θvsg and the grid phase θg because of the relationship of the power-phase difference angle curve of the synchronous generator as described above. That is, it is considered that the active power and the reactive power are not limited to match the grid phase θg because the active power and the reactive power are derived by limiting to Iref_dθvsg and Iref_qθvsg having the internal phase θvsg deviated from the grid phase θg.

Thus, the power conversion device 3 according to the present embodiment transforms the phases of the d-axis current command value and the q-axis current command value from the internal phase θvsg to the grid phase θg before limiting each of the d-axis current command value and the q-axis current command value. That is, the d-axis current command value having the internal phase θvsg and the q-axis current command value having the internal phase θvsg are transformed into the first d-axis current command value having the grid phase θg and the first q-axis current command value having the grid phase θg, respectively.

Thereafter, the d-axis current limit value and the q-axis current limit value are multiplied by the first d-axis current command value having the grid phase θg and the first q-axis current command value having the grid phase θg, respectively, whereby the second d-axis current command value having the grid phase θg and the second q-axis current command value having the grid phase θg are derived. The d-axis current limit value and the q-axis current limit value are values different from each other in the present embodiment. Thereafter, the second d-axis current command value having the grid phase θg and the second q-axis current command value having the grid phase θg are inversely transformed into the corrected d-axis current command value having the internal phase θvsg and the corrected q-axis current command value having the internal phase θvsg, respectively. In this manner, the d-axis current command value and the q-axis current command value are transformed into the first d-axis current command value and the first q-axis current command value in a state having the grid phase θg, not in a state having the internal phase θvsg, and then limits of different values are applied to the first d-axis current command value and the first q-axis current command value, respectively. By supplying the active power and the reactive power based on the corrected d-axis current command value and the corrected q-axis current command value to the grid 4, the active power and the reactive power can be limited to desired magnitudes in the grid 4 even when the internal phase θvsg and the grid phase θg are shifted from each other.

### (2) Specific Configuration of Power Conversion System

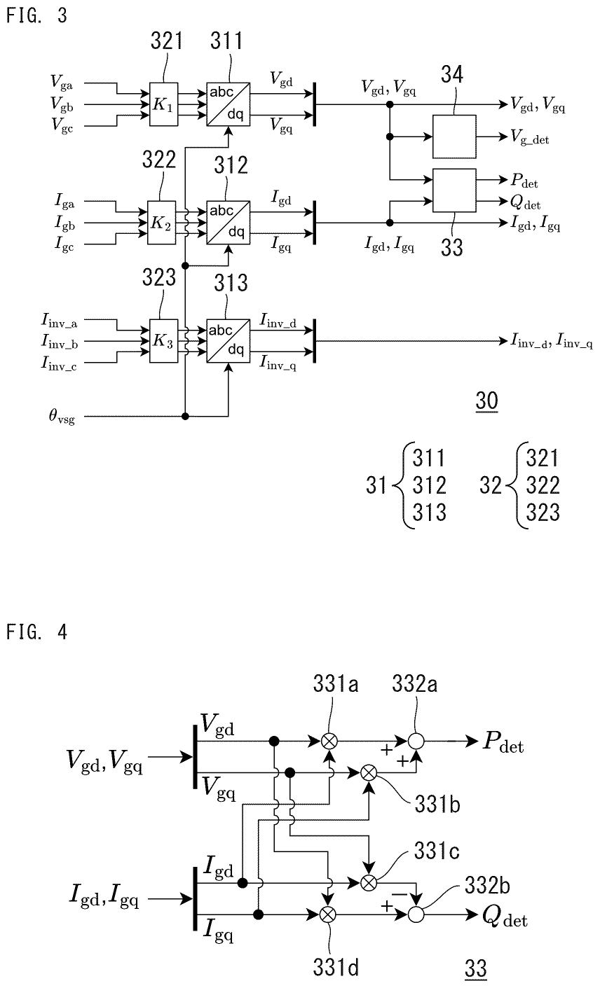

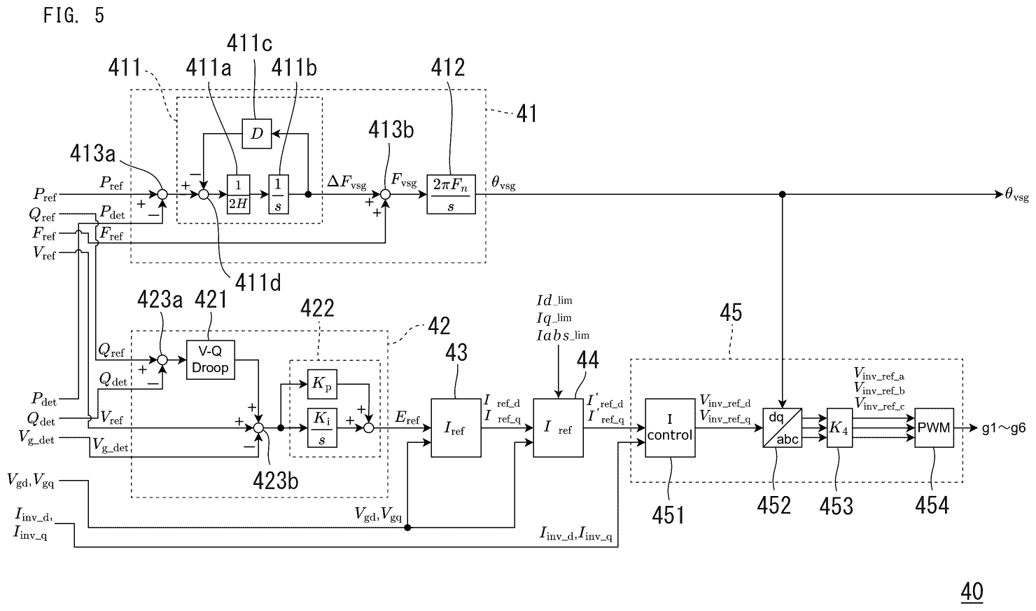

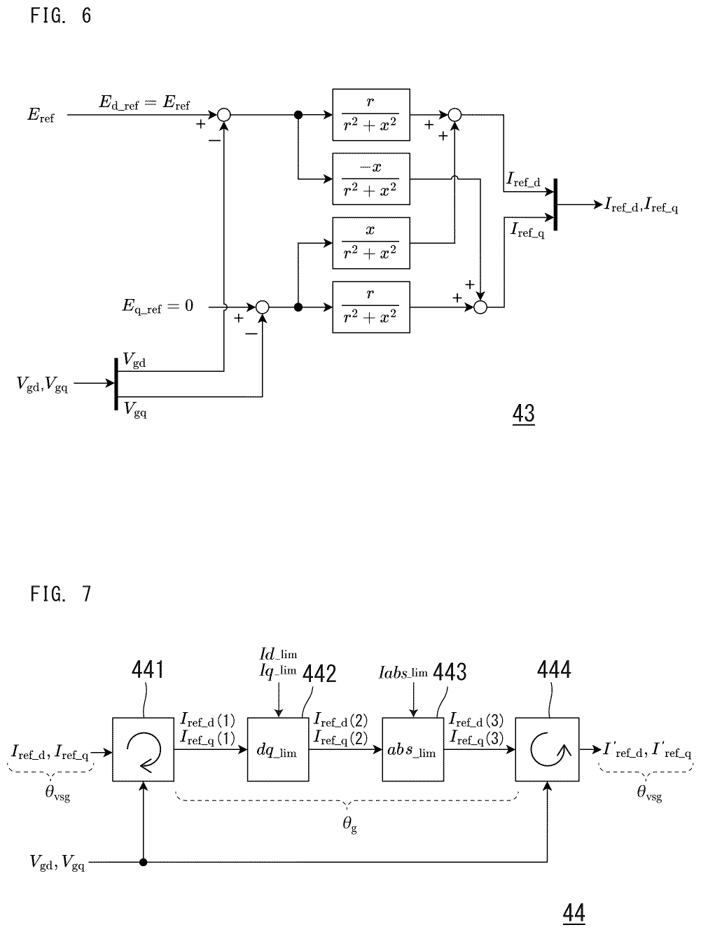

Hereinafter, an example of a specific configuration of the power conversion system 1 according to the present embodiment will be described. FIG. 3 is a configuration diagram of a measurement value calculation unit in FIG. 1. FIG. 4 is a configuration diagram of a power calculation unit in FIG. 3. FIG. 5 is a configuration diagram of a control signal derivation unit in FIG. 1. FIG. 6 is a configuration diagram of a current command value derivation unit in FIG. 5. FIG. 7 is a configuration diagram of a current command value correction unit in FIG. 5.

The power conversion system 1 is connected to the grid 4 and includes the DC power source 2 and the power conversion device 3. The power conversion device 3 performs virtual synchronous generator control with a virtual synchronous generator. The power conversion device 3 includes a grid interconnection unit 10 and an inverter controller 20. Each unit will be described below.

### (2-1) Grid Interconnection Unit

The grid interconnection unit 10 is connected between the DC power source 2 and the grid 4, and it adjusts power so that the power is interchangeable between the DC power source 2 and the grid 4. The grid interconnection unit 10 includes an inverter (power converter) 11 and an output line 12 extending from an output of the inverter 11 and connected to the grid 4.

The inverter 11 converts DC power of the DC power source 2 into AC power and outputs the AC power to the grid 4 via the output line 12. The inverter 11 includes, for example, six first to sixth transistors T1 to T6 each having a diode. By connecting the source of the first transistor T1 and the drain of the second transistor T2, the first transistor T1 and the second transistor T2 are connected in series. The drain of the first transistor T1 is connected to one side of the DC power source 2, and the source of the second transistor T2 is connected to the other side of the DC power source 2. Similarly, the third transistor T3 and the fourth transistor T4 are connected in series, the drain of the third transistor T3 is connected to one side of the DC power source 2, and the source of the fourth transistor T4 is connected to the other side of the DC power source 2. Similarly, the fifth transistor T5 and the sixth transistor T6 are connected in series, the drain of the fifth transistor T5 is connected to one side of the DC power source 2, and the source of the sixth transistor T6 is connected to the other side of the DC power source 2.

Switching control signals g1 to g6 to be described later are input to gates G to G6 of the first to sixth transistors T1 to T6, respectively. When each of the first to sixth transistors T1 to T6 is turned on and off by corresponding one of the switching control signals g1 to g6, the inverter 11 converts DC power of the DC power source 2 into AC power. The output line 12 includes a first output line 12a connected to the connection portion of the first transistor T1 and the second transistor T2, a second output line 12b connected to the connection portion of the third transistor T3 and the fourth transistor T4, and a third output line 12c connected to the connection portion of the fifth transistor T5 and the sixth transistor T6. The three-phase AC power output from the inverter 11 is supplied to the first to third output lines 12a to 12c.

The grid interconnection unit 10 includes a filter inductor 13, a filter capacitor 14, an inverter current sensor 15, an output current sensor 16, and an output voltage sensor 17. In the present embodiment, the filter inductor 13, the inverter current sensor 15, the filter capacitor 14, the output current sensor 16, and the output voltage sensor 17 are provided in the output line 12 in order from the inverter 11 side toward the grid 4 side.

The filter inductor 13 includes first to third filter inductors 13a to 13c. Each of the first to third filter inductors 13a to 13c is connected to corresponding one of the first to third output lines 12a to 12c. Each of the first to third filter inductors 13a to 13c is configured to filter noise of the AC power corresponding one of the first to third output lines 12a to 12c, and works as, for example, a low-pass filter.

The filter capacitor 14 includes first to third filter capacitors 14a to 14c. Each of the first to third filter capacitors 14a to 14c is connected to corresponding one of the first to third output lines 12a to 12c. Each of the first to third filter capacitors 14a to 14c is configured to filter noise of the AC power by charging the AC power of corresponding one of the first to third output lines 12a to 12c.

The inverter current sensor 15 includes first to third inverter current sensors 15a to 15c. Each of the first to third inverter current sensors 15a to 15c is connected to corresponding one of the first to third output lines 12a to 12c on the side closer to the inverter 11 than the grid 4 side. In the present embodiment, the first to third inverter current sensors 15a to 15c are connected to the filter inductor 13 side between the filter inductor 13 and the grid 4. The first to third inverter current sensors 15a to 15c measure inverter output currents Iinv_a, Iinv_b, and Iinv_c, which are measurement values of inverter currents of three phases (phase a, phase b, phase c) output from the inverter 11, respectively.

The output current sensor 16 includes first to third output current sensors 16a to 16c. In the present embodiment, each of the first to third output current sensors 16a to 16c is connected to corresponding one of the first to third output lines 12a to 12c between the filter capacitor 14 and the grid 4. The first to third output current sensors 16a to 16c measure output currents Iga, Igb, and Igc, which are measurement values of the output currents of the three phases (phase a, phase b, phase c) output from the inverter 11, respectively.

The output voltage sensor 17 includes first to third output voltage sensors 17a to 17c. In the present embodiment, each of the first to third output voltage sensors 17a to 17c is connected to corresponding one of the first to third output lines 12a to 12c between the filter capacitor 14 and the grid 4. The first to third output voltage sensors 17a to 17c measure output voltages Vga, Vgb, and Vgc, which are measurement values of output voltages of three phases (phase a, phase b, phase c) output from the inverter 11, respectively.

The output voltages Vga, Vgb, and Vgc, the output currents Iga, Igb, and Igc, and the inverter output currents Iinv_a, Iinv_b, and Iinv_c are input to the inverter controller 20.

### (2-2) Inverter Controller

The inverter controller 20 controls the inverter 11 such that virtual synchronous generator control is performed by a virtual synchronous generator simulating a synchronous generator. The inverter controller 20 includes a measurement value calculation unit 30 and a control signal derivation unit 40.

### (a) Measurement Value Calculation Unit

The measurement value calculation unit 30 is configured as illustrated in FIG. 3, and it derives various voltages, power, and the like required by the control signal derivation unit 40 on the basis of the output voltages Vga, Vgb, and Vgc, the output currents Iga, Igb, and Igc, and the inverter output currents Iinv_a, Iinv_b, and Iinv_c from the grid interconnection unit 10. The measurement value calculation unit 30 includes a dq transformation unit 31, a gain unit 32, a power calculation unit 33, and a power absolute value calculation unit 34. The dq transformation unit 31 includes a voltage dq transformation unit 311, a current dq transformation unit 312, and an inverter current dq transformation unit 313. The gain unit 32 includes a first gain unit 321, a second gain unit 322, and a third gain unit 323.

The voltage dq transformation unit 311 performs dq transformation on the voltages obtained by multiplying a first gain K1 by the output voltages Vga, Vgb, and Vgc with the first gain unit 321 using the internal phase θvsg. As a result, the voltage dq transformation unit 311 derives a d-axis voltage Vgd that is a d-axis component and a q-axis voltage Vgq that is a q-axis component on the internal-phase-synchronized dq coordinate system of the output voltages Vga, Vgb, and Vgc. The internal-phase-synchronized dq coordinate system rotates in synchronization with the internal phase θvsg as described above. The d-axis voltage Vgd and the q-axis voltage Vgq have the internal phase θvsg.

Derivation of the d-axis voltage Vgd and the q-axis voltage Vgq with the voltage dq transformation unit 311 is expressed by, for example, the following Formula (6).

$$\begin{matrix}[ Mathematical Formula 1 ] & \\ ( \begin{matrix}{V}_{gd} \\ {V}_{gq}\end{matrix} ) = \sqrt{\frac{2}{3}} k ( \begin{matrix}cos ( {θ}_{ref} + {θ}_{0} ) & cos ( {θ}_{ref} + {θ}_{0} - \frac{2 π}{3} ) & cos ( {θ}_{ref} + {θ}_{0} + \frac{2 π}{3} ) \\ - sin ( {θ}_{ref} + {θ}_{0} ) & - sin ( {θ}_{ref} + {θ}_{0} - \frac{2 π}{3} ) & - sin ( {θ}_{ref} + {θ}_{0} + \frac{2 π}{3} )\end{matrix} ) ( \begin{matrix}{V}_{ga} \\ {V}_{gb} \\ {V}_{gc}\end{matrix} ) & ( 6 )\end{matrix}$$

Here, the constant k is a free-selected positive real number, and θ0 is a constant of a real number.
θref in Formula (6) is the reference phase θref.

In the present embodiment, the d-axis voltage Vgd and the q-axis voltage Vgq on the internal-phase-synchronized dq coordinate system are derived by the following Formula (7) with k=1, θ0=0 rad, and reference phase θref=internal phase θvsg in Formula (6).

$$\begin{matrix}[ Mathematical Formula 2 ] & \\ ( \begin{matrix}{V}_{gd} \\ {V}_{gq}\end{matrix} ) = \sqrt{\frac{2}{3}} ( \begin{matrix}cos ( {θ}_{vsg} ) & cos ( {θ}_{vsg} - \frac{2 π}{3} ) & cos ( {θ}_{vsg} + \frac{2 π}{3} ) \\ - sin ( {θ}_{vsg} ) & - sin ( {θ}_{vsg} - \frac{2 π}{3} ) & - sin ( {θ}_{vsg} + \frac{2 π}{3} )\end{matrix} ) ( \begin{matrix}{V}_{ga} \\ {V}_{gb} \\ {V}_{gc}\end{matrix} ) & ( 7 )\end{matrix}$$

The current dq transformation unit 312 performs dq transformation on the currents obtained by multiplying a second gain K2 by the output currents Iga, Igb, and Igc with the second gain unit 322 using the internal phase θvsg. As a result, the current dq transformation unit 312 derives a d-axis current Igd that is a d-axis component and a q-axis current Igq that is a q-axis component on the internal-phase-synchronized dq coordinate system of the output currents Iga, Igb, and Igc. The d-axis current Igd and the q-axis current Igq have the internal phase θvsg.

Derivation of the d-axis current Igd and the q-axis current Igq with the current dq transformation unit 312 is expressed by, for example, the following Formula (8).

$$\begin{matrix}[ Mathematical Formula 3 ] & \\ ( \begin{matrix}{I}_{gd} \\ {I}_{gq}\end{matrix} ) = \sqrt{\frac{2}{3}} k ( \begin{matrix}cos ( {θ}_{ref} + {θ}_{0} ) & cos ( {θ}_{ref} + {θ}_{0} - \frac{2 π}{3} ) & cos ( {θ}_{ref} + {θ}_{0} + \frac{2 π}{3} ) \\ - sin ( {θ}_{ref} + {θ}_{0} ) & - sin ( {θ}_{ref} + {θ}_{0} - \frac{2 π}{3} ) & - sin ( {θ}_{ref} + {θ}_{0} + \frac{2 π}{3} )\end{matrix} ) ( \begin{matrix}{I}_{ga} \\ {I}_{gb} \\ {I}_{gc}\end{matrix} ) & ( 8 )\end{matrix}$$

Here, as in Formula (6), the constant k is a free-selected positive real number, and θ0 is a constant of a real number.

As in Formula (6), θref in Formula (8) is the reference phase θref.

In the present embodiment, the d-axis current Igd and the q-axis current Igq on the internal-phase-synchronized dq coordinate system are derived from the following Formula (9) with k=1, θ0=0 rad, and reference phase θref=internal phase θvsg in Formula (8).

$$\begin{matrix}[ Mathematical Formula 4 ] & \\ ( \begin{matrix}{I}_{gd} \\ {I}_{gq}\end{matrix} ) = \sqrt{\frac{2}{3}} ( \begin{matrix}cos ( {θ}_{vsg} ) & cos ( {θ}_{vsg} - \frac{2 π}{3} ) & cos ( {θ}_{vsg} + \frac{2 π}{3} ) \\ - sin ( {θ}_{vsg} ) & - sin ( {θ}_{vsg} - \frac{2 π}{3} ) & - sin ( {θ}_{vsg} + \frac{2 π}{3} )\end{matrix} ) ( \begin{matrix}{I}_{ga} \\ {I}_{gb} \\ {I}_{gc}\end{matrix} ) & ( 9 )\end{matrix}$$

The inverter current dq transformation unit 313 performs dq transformation on the currents obtained by multiplying a third gain K3 by the inverter output currents Iinv_a, Iinv_b, and Iinv_c with the third gain unit 323 using the internal phase θvsg. As a result, the inverter current dq transformation unit 313 derives a d-axis inverter current Iinv_d that is a d-axis component on the internal-phase-synchronized dq coordinate system of the inverter output currents Iinv_a, Iinv_b, and Iinv_c and a q-axis inverter current Iinv_q that is a q-axis component. The d-axis inverter current Iinv_d and the q-axis inverter current Iinv_q have the internal phase θvsg.

Derivation of the d-axis inverter current Iinv_d and the q-axis inverter current Iinv_q with the inverter current dq transformation unit 313 is expressed by, for example, the following Formula (10).

$$\begin{matrix}[ Mathematical Formula 5 ] & \\ ( \begin{matrix}{I}_{inv \_ d} \\ {I}_{inv \_ q}\end{matrix} ) = \sqrt{\frac{2}{3}} k ( \begin{matrix}cos ( {θ}_{ref} + {θ}_{0} ) & cos ( {θ}_{ref} + {θ}_{0} - \frac{2 π}{3} ) & cos ( {θ}_{ref} + {θ}_{0} + \frac{2 π}{3} ) \\ - sin ( {θ}_{ref} + {θ}_{0} ) & - sin ( {θ}_{ref} + {θ}_{0} - \frac{2 π}{3} ) & - sin ( {θ}_{ref} + {θ}_{0} + \frac{2 π}{3} )\end{matrix} ) ( \begin{matrix}{I}_{inv \_ a} \\ {I}_{inv \_ b} \\ {I}_{inv \_ c}\end{matrix} ) & ( 10 )\end{matrix}$$

Here, as in Formula (6), the constant k is a free-selected positive real number, and θ0 is a constant of a real number.

As in Formula (6), θref in Formula (10) is the reference phase θref.

In the present embodiment, the d-axis inverter current Iinv_d and the q-axis inverter current Iinv_q on the internal-phase-synchronized dq coordinate system are derived from the following Formula (11) with k=1, θ0=0 rad, and reference phase θref=internal phase vsg in Formula (10).

$$\begin{matrix}[ Mathematical Formula 6 ] & \\ ( \begin{matrix}{I}_{inv \_ d} \\ {I}_{inv \_ q}\end{matrix} ) = \sqrt{\frac{2}{3}} ( \begin{matrix}cos ( {θ}_{vsg} ) & cos ( {θ}_{vsg} - \frac{2 π}{3} ) & cos ( {θ}_{vsg} + \frac{2 π}{3} ) \\ - sin ( {θ}_{vsg} ) & - sin ( {θ}_{vsg} - \frac{2 π}{3} ) & - sin ( {θ}_{vsg} + \frac{2 π}{3} )\end{matrix} ) ( \begin{matrix}{I}_{inv \_ a} \\ {I}_{inv \_ b} \\ {I}_{inv \_ c}\end{matrix} ) & ( 11 )\end{matrix}$$

The power calculation unit 33 derives the active power Pdet and the reactive power Qdet from the d-axis current Igd, the d-axis voltage Vgd, the q-axis current Igq, and the q-axis voltage Vgq, for example, with the configuration illustrated in FIG. 4. In the configuration of FIG. 4, the power calculation unit 33 includes multipliers 331a to 331d and adder-subtractors 332a and 332b. The active power Pdet and the reactive power Qdet are derived from, for example, the following Formulas (12-1) and (12-2). The active power Pdet and the reactive power Qdet have the internal phase θvsg.

$$P det = Vgd \cdot Igd + Vgq \cdot Igq \qquad ( 12 - 1 )$$

$$Q det = Vgd \cdot Igq - Vgq \cdot Igd \qquad ( 12 - 2 )$$

The power absolute value calculation unit 34 can derive an output voltage absolute value Vg_det from the d-axis voltage Vgd and the q-axis voltage Vgq from, for example, the following Formula (13). The output voltage absolute value Vg_det has the internal phase θvsg.

$$\begin{matrix}[ Mathematical Formula 7 ] & \\ {V}_{g \_ det} = \sqrt{{V}_{gd}^{2} + {V}_{gq}^{2}} & ( 13 )\end{matrix}$$

The d-axis voltage Vgd, the q-axis voltage Vgq, the active power Pdet, the reactive power Qdet, the d-axis inverter current Iinv_d, the q-axis inverter current Iinv_q, and the output voltage absolute value Vg_det are input to the control signal derivation unit 40.

### (b) Control Signal Derivation Unit

The control signal derivation unit 40 derives switching control signals g1 to g6 for controlling the inverter 11. The control signal derivation unit 40 is configured as illustrated in FIG. 5. The control signal derivation unit 40 receives inputs of the d-axis voltage Vgd, the q-axis voltage Vgq, the active power Pdet, the reactive power Qdet, the d-axis inverter current Iinv_d, the q-axis inverter current Iinv_q, and the output voltage absolute value Vg_det from the measurement value calculation unit 30. The control signal derivation unit 40 receives inputs of an active power command value Pref, a reactive power command value Qref, an external frequency command value Fref, and an external voltage command value Vref from the outside. The control signal derivation unit 40 receives inputs of a d-axis current limit value Id_lim, a q-axis current limit value Iq_lim, and a current absolute value limit value Iabs_lim from the outside. The outside is, for example, an external device such as a microgrid control device. The microgrid control device is an apparatus that controls a system called a microgrid that supplies power to a load using the DC power source 2 in a specific area.

The control signal derivation unit 40 includes an internal phase derivation unit 41, an AVR unit 42, a current command value derivation unit 43, a current command value correction unit 44, and a switching controller 45.

### (b1) Internal Phase Derivation Unit

The internal phase derivation unit 41 derives the internal phase θvsg. Specifically, the internal phase derivation unit 41 derives an internal frequency deviation ΔFvsg of the virtual synchronous generator from the deviation between the active power Pdet and the active power command value Pref input to the internal phase derivation unit 41 (an example of the inverter controller 20) from the outside. Further, the internal phase derivation unit 41 derives the internal phase θvsg from the internal frequency deviation ΔFvsg and the external frequency command value Fref input to the internal phase derivation unit 41 (an example of the inverter controller 20) from the outside.

The internal phase derivation unit 41 includes a simulation calculation unit 411, an angular frequency integrator 412, an adder-subtractor 413a, and an adder-subtractor 413b. The simulation calculation unit 411 includes a unit inertia constant unit 411a, an integrator 411b, a braking controller 411c, and an adder-subtractor 411d.

The adder-subtractor 413a derives a deviation between the active power Pdet and the active power command value Pref.

The simulation calculation unit 411 (a part of the internal phase derivation unit 41) derives the internal frequency deviation ΔFvsg by performing predetermined calculation processing using the deviation between the active power Pdet and the active power command value Pref and an oscillation equation.

Derivation of the internal frequency deviation ΔFvsg will be further described. First, the adder-subtractor 411d subtracts a value obtained by multiplying the internal frequency deviation ΔFvsg by a unit braking coefficient D from the deviation between the active power Pdet and the active power command value Pref. The unit braking coefficient D is a coefficient that determines the F-P droop characteristic of the active power Pdet and the internal frequency deviation ΔFvsg. The product obtained by multiplying the internal frequency deviation ΔFvsg by the unit braking coefficient D is set by the braking controller 411c on the basis of the internal frequency deviation ΔFvsg. The unit inertia constant unit 411a multiplies a subtraction result obtained by subtracting a value obtained by multiplying the internal frequency deviation ΔFvsg by the unit braking coefficient D from the deviation between the active power Pdet and the active power command value Pref by ½H. H is a unit inertia constant that simulates the inertia of the virtual synchronous generator. The integrator 411b integrates the multiplication result. As a result, the internal frequency deviation ΔFvsg is derived.

Next, the adder-subtractor 413b (a part of the internal phase derivation unit 41) derives the internal frequency Fvsg (unit: pu) of the virtual synchronous generator by adding the external frequency command value Fref (unit: pu) pu to the internal frequency deviation ΔFvsg (unit: pu). The angular frequency integrator 412 (a part of the internal phase derivation unit 41) derives the internal phase θvsg (unit: rad) by integrating an angular frequency 2πFvsgFn (unit: rad/s) obtained by multiplying the internal frequency Fvsg (unit: pu) of the virtual synchronous generator by 2πFn (unit: rad/s). Fn is a rated frequency (unit: Hz).

The internal phase θvsg derived by the internal phase derivation unit 41 is used when the d-axis voltage Vgd and the q-axis voltage Vgq are derived in the voltage dq transformation unit 311, when the d-axis current Igd and the q-axis current Igq are derived in the current dq transformation unit 312, and when the d-axis inverter current Iinv_d and the q-axis inverter current Iinv_q are derived in the inverter current dq transformation unit 313. The internal phase θvsg is used when the switching control signals g1 to g6 are derived in the switching controller 45.

### (b2) AVR Unit

The AVR unit 42 performs automatic voltage control in the virtual synchronous generator. The AVR unit 42 derives the internal voltage Eref of the virtual synchronous generator from the reactive power Qdet, the reactive power command value Qref input to the AVR unit 42 (an example of the inverter controller 20) from the outside, the output voltage absolute value Vg_det, and the external voltage command value Vref input to the AVR unit 42 (an example of the inverter controller 20) from the outside.

The AVR unit 42 includes a droop/first-order lag calculation unit 421, an internal voltage calculation unit 422, an adder-subtractor 423a, and an adder-subtractor 423b.

More specifically, in the AVR unit 42, the adder-subtractor 423a (a part of the AVR unit 42) derives a deviation between the reactive power Qdet and the reactive power command value Qref. The droop/first-order lag calculation unit 421 (a part of the AVR unit 42) performs a predetermined calculation on the deviation between the reactive power Qdet and the reactive power command value Qref on the basis of the V-Q droop characteristic of the AVR (an example of the droop characteristic of the AVR) and provides a first-order lag element to the calculation result. The V-Q droop characteristic (drooping characteristic) is a negative proportional characteristic provided between the reactive power and the output voltage so that the virtual synchronous generator can perform reactive power control during grid interconnection operation and perform output voltage control during self-sustained operation. Specifically, the V-Q droop characteristic is a characteristic in which the output reactive power is controlled to decrease when the output voltage of the virtual synchronous generator increases, and the output reactive power is controlled to increase when the output voltage of the virtual synchronous generator decreases. The first-order lag element is provided to prevent the response to the deviation between the reactive power Qdet and the reactive power command value Qref from becoming too sensitive.

The adder-subtractor 423b (a part of the AVR unit 42) subtracts the output voltage absolute value Vg_det from the sum of the result to which the first-order lag element is provided and the external voltage command value Vref. The internal voltage calculation unit 422 (a part of the AVR unit 42) derives the internal voltage Eref by applying processing with feedback control to the output of the adder-subtractor 423b. Examples of the processing with the feedback control include PI control. For example, the feedback control with the internal voltage calculation unit 422 is performed by performing proportional integral calculation on the output of the adder-subtractor 423b using the transfer function KA(s)=Kp+Ki/s. Here, Kp is a proportional gain, and Ki is an integral gain.

### (b3) Current Command Value Derivation Unit

The current command value derivation unit 43 derives the current command values Iref_d and Iref_q. As illustrated in FIG. 5, the current command value derivation unit 43 receives an input of the internal voltage Eref from the AVR unit 42. The current command value derivation unit 43 receives inputs of the d-axis voltage Vgd and the q-axis voltage Vgq from the measurement value calculation unit 30. The current command value derivation unit 43 has an internal impedance z of the virtual synchronous generator to simulate the impedance of the synchronous generator. The current command value derivation unit 43 derives the d-axis current command value Iref_d and the q-axis current command value Iref_q from the internal voltage Eref, the d-axis voltage Vgd, the q-axis voltage Vgq, and the internal impedance z of the virtual synchronous generator. Each of the d-axis current command value Iref_d and the q-axis current command value Iref_q has the internal phase θvsg.

Specifically, the current command value derivation unit 43 derives the d-axis current command value Iref_d and the q-axis current command value Iref_q with the configuration illustrated in FIG. 6. Here, in the configuration of FIG. 6, the d-axis current command value Iref_d and the q-axis current command value Iref_q can be derived from, for example, the following Formula (14).

$$\begin{matrix}[ Mathematical Formula 8 ] & \\ ( \begin{matrix}{I}_{ref \_ d} \\ {I}_{ref \_ q}\end{matrix} ) = \frac{1}{{r}^{2} + {x}^{2}} ( \begin{matrix}r & x \\ - x & r\end{matrix} ) \{ ( \begin{matrix}{E}_{ref} \\ 0\end{matrix} ) - ( \begin{matrix}{V}_{gd} \\ {V}_{gq}\end{matrix} ) \} & ( 14 )\end{matrix}$$

Here, r is the winding resistance of the virtual armature of the virtual synchronous generator, and x is the winding reactance of the virtual armature of the virtual synchronous generator.

The internal impedance z of the virtual synchronous generator is virtually simulated based on the winding resistance r and the winding reactance x.

### (b4) Current Command Value Correction Unit

The current command value correction unit 44 transforms the d-axis current command value Iref_d and the q-axis current command value Iref_q into a first d-axis current command value Iref_d(1) and a first q-axis current command value Iref_q(1), respectively, in consideration of the phase difference between the internal phase θvsg and the grid phase θg. Thereafter, the current command value correction unit 44 derives the corrected d-axis current command value I′ref_d and the corrected q-axis current command value I′ref_q using a value obtained by limiting at least one of the first d-axis current command value Iref_d(1) and the first q-axis current command value Iref_q(1). Hereinafter, the current command value correction unit 44 will be specifically described.

As illustrated in FIG. 7, the current command value correction unit 44 includes a command value transformation unit 441, a current limiting unit 442, an absolute value limiting unit 443, and a command value inverse transformation unit 444.

(i)

The command value transformation unit 441 transforms the d-axis current command value Iref_d having the internal phase θvsg and the q-axis current command value Iref_q having the internal phase θvsg into a first d-axis current command value Iref_d(1) having the grid phase θg and a first q-axis current command value Iref_q(1) having the grid phase θg, respectively.

Here, the transformation with the command value transformation unit 441 is not limited to this configuration, and examples thereof include, first, coordinate transformation of coordinate points of the d-axis current command value and the q-axis current command value on the internal-phase-synchronized dq coordinate system, second, rotational transformation of the internal-phase-synchronized dq coordinate system, and third, transformation with a mathematical formula.

In the case of the first transformation, the command value transformation unit 441 coordinate-transforms the coordinate points of the d-axis current command value Iref_d and the coordinate points of the q-axis current command value Iref_q on the internal-phase-synchronized dq coordinate system into coordinate points of the first d-axis current command value Iref_d(1) and coordinate points of the first q-axis current command value Iref_q(1) on the grid-phase-synchronized dq coordinate system, respectively. That is, the command value transformation unit 441 coordinate-transforms the coordinate points of the d-axis current command value Iref_d having the internal phase θvsg on the internal-phase-synchronized dq coordinate system into the coordinate points of the first d-axis current command value Iref_d(1) having the grid phase θg on the grid-phase-synchronized dq coordinate system. The command value transformation unit 441 coordinate-transforms the coordinate points of the q-axis current command value Iref_q having the internal phase θvsg on the internal-phase-synchronized dq coordinate system into the coordinate points of the first q-axis current command value Iref_q(1) having the grid phase θg on the grid-phase-synchronized dq coordinate system.

In the case of the second transformation, the command value transformation unit 441 performs rotational transformation on the internal-phase-synchronized dq coordinate system from the internal phase θvsg to the grid phase θg, thereby transforming the internal-phase-synchronized dq coordinate system into a grid-phase-synchronized dq coordinate system that rotates in synchronization with the grid phase θg. Thus, the command value transformation unit 441 transforms the d-axis current command value Iref_d having the internal phase θvsg and the q-axis current command value Iref_q having the internal phase θvsg into a first d-axis current command value Iref_d(1) having the grid phase θg and a first q-axis current command value Iref_q(1) having the grid phase θg, respectively.

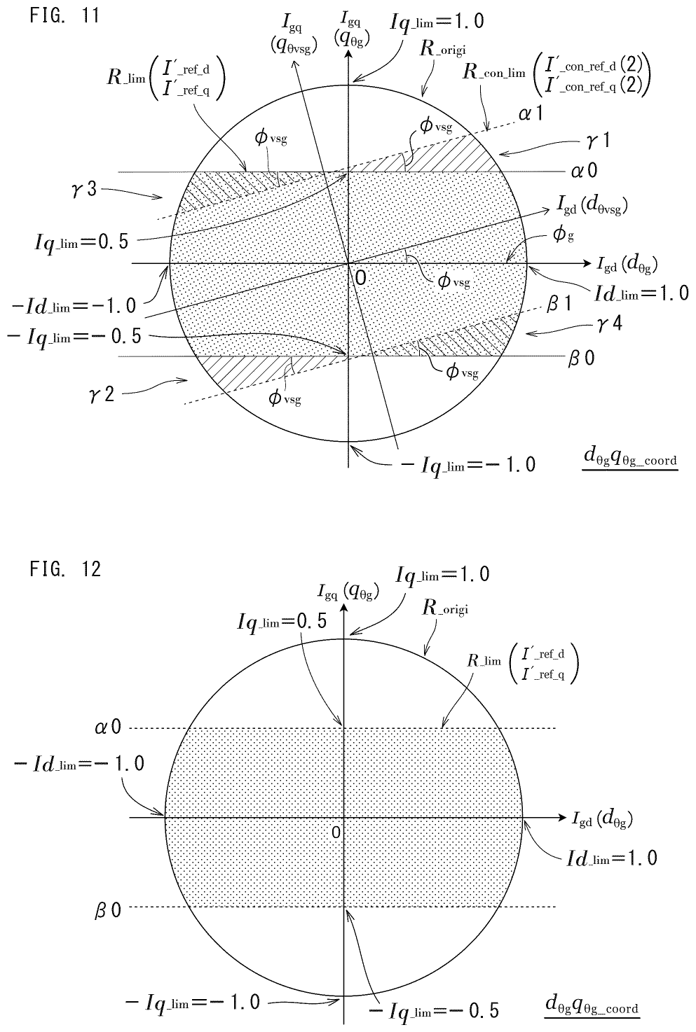

With reference to FIG. 2, in the case of the second transformation, the command value transformation unit 441 rotates the internal-phase-synchronized dq coordinate system around the intersection of the dθvsg axis and the qθvsg axis (or the intersection of the dog axis and the qθg axis) by the phase difference 8 between the internal phase θvsg and the grid phase θg so that the internal-phase-synchronized dq coordinate system coincides with the grid-phase-synchronized dq coordinate system. Here, in the case of FIG. 2, 8=θvsg-Og is satisfied. In the case of FIG. 11 described later, δ=φvsg is satisfied. By this rotation, according to the example of FIG. 2, Iref_dθvsg (corresponding to the d-axis current command value Iref_d having the internal phase θvsg described above), which is a dθvsg axis component of the internal-phase-synchronized dq coordinate system, is transformed into Iref_dθg (corresponding to the first d-axis current command value Iref_d(1) having the grid phase θg described above), which is a dog axis component of the grid-phase-synchronized dq coordinate system. Similarly, Iref_qθvsg (corresponding to the q-axis current command value Iref_q having the internal phase θvsg described above), which is a qθvsg axis component of the internal-phase-synchronized dq coordinate system, is transformed into Iref_qθg (corresponding to the first q-axis current command value Iref_q(1) having the grid phase θg described above), which is a qθg-axis component of the grid-phase-synchronized dq coordinate system.

In the case of the third transformation, the command value transformation unit 441 derives the first d-axis current command value Iref_d(1) having the grid phase θg and the first q-axis current command value Iref_q(1) having the grid phase θg from the following Formula (1).

$$\begin{matrix}[ Mathematical Formula 9 ] & \\ ( \begin{matrix}{I}_{ref \_ d ( 1 )} \\ {I}_{ref \_ q ( 1 )}\end{matrix} ) = \frac{1}{\sqrt{{V}_{gd}^{2} + {V}_{gq}^{2}}} ( \begin{matrix}{V}_{gd} & {V}_{gq} \\ - {V}_{gq} & {V}_{gd}\end{matrix} ) ( \begin{matrix}{I}_{ref \_ d} \\ {I}_{ref \_ q}\end{matrix} ) & ( 1 )\end{matrix}$$

(ii)

The current limiting unit 442 limits the first d-axis current command value Iref_d(1) and the first q-axis current command value Iref_q(1) to adjust each of the active power Pdet and the reactive power Qdet. Specifically, the current limiting unit 442 derives a second d-axis current command value Iref_d(2) having the grid phase θg and a second q-axis current command value Iref_q(2) having the grid phase θg by using the d-axis current limit value Id_lim and the q-axis current limit value Iq_lim input to the current limiting unit 442 (a part of the inverter controller 20) from the outside, the first d-axis current command value Iref_d(1), and the first q-axis current command value Iref_q(1). The second d-axis current command value Iref_d(2) having the grid phase θg is obtained by multiplying the d-axis current limit value Id_lim by the first d-axis current command value Iref_d(1). The second q-axis current command value Iref_q(2) having the grid phase θg is obtained by multiplying the q-axis current limit value Iq_lim by the first q-axis current command value Iref_q(1). Each of the d-axis current limit value Id_lim and the q-axis current limit value Iq_lim is a value of 0 or more, and the d-axis current limit value Id_lim and the q-axis current limit value Iq_lim are different values.

The current limiting unit 442 derives the second d-axis current command value Iref_d(2) having the grid phase θg and the second q-axis current command value Iref_q(2) having the grid phase θg from the following Formula (2).

$$\begin{matrix}[ Mathematical Formula 10 ] & \\ ( \begin{matrix}{I}_{ref \_ d ( 2 )} \\ {I}_{ref \_ q ( 2 )}\end{matrix} ) = ( \begin{matrix}Max ( Min ( {I}_{ref \_ d ( 1 )} , {I}_{d \_ lim} ) , - {I}_{d \_ lim} ) \\ Max ( Min ( {I}_{ref \_ q ( 1 )} , {I}_{q \_ lim} ) , - {I}_{q \_ lim} )\end{matrix} ) & ( 2 )\end{matrix}$$

(iii)

The absolute value limiting unit 443 limits the second d-axis current command value Iref_d(2) and the second q-axis current command value Iref_q(2) to commonly adjust the active power Pdet and the reactive power Qdet. Specifically, the absolute value limiting unit 443 derives a third d-axis current command value Iref_d(3) having the grid phase θg and a third q-axis current command value Iref_q(3) having the grid phase θg using the current absolute value limit value Iabs_lim input to the absolute value limiting unit 443 (a part of the inverter controller 20) from the outside, the second d-axis current command value Iref_d(2), and the second q-axis current command value Iref_q(2). The third d-axis current command value Iref_d(3) having the grid phase θg is obtained by multiplying the current absolute value limit value Iabs_lim by the second d-axis current command value Iref_d(2). The third q-axis current command value Iref_q(3) having the grid phase θg is obtained by multiplying the current absolute value limit value Iabs_lim by the second q-axis current command value Iref_q(2). The current absolute value limit value Iabs_lim is a value of 0 or more.

The absolute value limiting unit 443 derives the third d-axis current command value Iref_d(3) having the grid phase θg and the third q-axis current command value Iref_q(3) having the grid phase θg from the following Formula (4).

$$\begin{matrix}[ Mathematical Formula 11 ] & \\ ( \begin{matrix}{I}_{ref \_ d ( 3 )} \\ {I}_{ref \_ q ( 3 )}\end{matrix} ) = \frac{Min ( \sqrt{{( {I}_{ref \_ d ( 2 )} )}^{2} + {( {I}_{ref \_ q ( 2 )} )}^{2}} , {I}_{abs \_ lim} )}{{( {I}_{ref \_ d ( 2 )} )}^{2} + {( {I}_{ref \_ q ( 2 )} )}^{2}} ( \begin{matrix}{I}_{ref \_ d ( 2 )} \\ {I}_{ref \_ q ( 2 )}\end{matrix} ) & ( 4 )\end{matrix}$$

(iv)

The command value inverse transformation unit 444 inversely transforms the third d-axis current command value Iref_d(3) having the grid phase θg and the third q-axis current command value Iref_q(3) having the grid phase θg into the corrected d-axis current command value I′ref_d having the internal phase θvsg and the corrected q-axis current command value I′ref_q having the internal phase θvsg, respectively.

Here, the inverse transformation with the command value inverse transformation unit 444 is not limited to this configuration, and examples thereof include, first, coordinate inverse transformation of the coordinate points of the third d-axis current command value Iref_d(3) and the third q-axis current command value Iref_q(3) on the grid-phase-synchronized dq coordinate system, second, inverse rotational transformation of the grid-phase-synchronized dq coordinate system, and third, inverse transformation with a mathematical formula. The command value inverse transformation unit 444 performs inverse transformation corresponding to the transformation in the command value transformation unit 441. For example, when coordinate transformation of coordinate points is performed in the command value transformation unit 441, the command value inverse transformation unit 444 performs coordinate inverse transformation of the coordinate points. For example, when rotational transformation of the internal-phase-synchronized dq coordinate system is performed in the command value transformation unit 441, the command value inverse transformation unit 444 performs inverse rotational transformation of the grid-phase-synchronized dq coordinate system. Further, for example, when transformation with a mathematical formula is performed in the command value transformation unit 441, the command value inverse transformation unit 444 performs inverse transformation with the mathematical formula.

In the case of the first inverse transformation, the command value inverse transformation unit 444 inversely coordinate-transforms the coordinate points of the third d-axis current command value Iref_d(3) and the coordinate points of the third q-axis current command value Iref_q(3) on the grid-phase-synchronized dq coordinate system into coordinate points of the corrected d-axis current command value I′ref_d and coordinate points of the corrected q-axis current command value I′ref_q on the internal-phase-synchronized dq coordinate system, respectively. Specifically, the command value inverse transformation unit 444 inversely coordinate-transforms the coordinate points of the third d-axis current command value Iref_d(3) having the grid phase θg on the grid-phase-synchronized dq coordinate system into the coordinate points of the corrected d-axis current command value I′ref_d having the internal phase θvsg on the internal-phase-synchronized dq coordinate system. The command value inverse transformation unit 444 inversely coordinate-transforms the coordinate points of the third q-axis current command value Iref_q(3) having the grid phase θg on the grid-phase-synchronized dq coordinate system into the coordinate points of the corrected q-axis current command value I′ref_q having the internal phase θvsg on the internal-phase-synchronized dq coordinate system.

In the case of the second inverse transformation, the command value inverse transformation unit 444 performs inverse rotational transformation on the rotationally transformed grid-phase-synchronized dq coordinate system in the command value transformation unit 441 from the grid phase θg to the internal phase θvsg, thereby inversely transforming the grid-phase-synchronized dq coordinate system into the internal-phase-synchronized dq coordinate system. Thus, the command value inverse transformation unit 444 inversely transforms the third d-axis current command value Iref_d(3) having the grid phase θg and the third q-axis current command value Iref_q(3) having the grid phase θg into the corrected d-axis current command value I′ref_d having the internal phase θvsg and the corrected q-axis current command value I′ref_q having the internal phase θvsg, respectively.

With reference to FIG. 2, in the case of the second inverse transformation, the command value inverse transformation unit 444 inversely rotates the grid-phase-synchronized dq coordinate system around the intersection of the dθvsg axis and the qθvsg axis (or the intersection of the dog axis and the qθg axis) by the phase difference & between the grid phase θg and the internal phase θvsg so that the grid-phase-synchronized dq coordinate system coincides with the internal-phase-synchronized dq coordinate system. Here, in the case of FIG. 2, 8=θvsg-Og is satisfied. In the case of FIG. 11 described later, δ=φvsg is satisfied. By this inverse rotation, according to the example of FIG. 2, Iref_dθg (corresponding to the above-described third d-axis current command value Iref_d(3) having the grid phase θg), which is a deg-axis component of the grid-phase-synchronized dq coordinate system, is transformed into Iref_dθvsg (corresponding to the above-described corrected d-axis current command value I′ref_d), which is a dθvsg axis component of the internal-phase-synchronized dq coordinate system. Similarly, Iref_qθg (corresponding to the above-described third q-axis current command value Iref_q(3) having the grid phase θg), which is a qθg-axis component of the grid-phase-synchronized dq coordinate system, is transformed into Iref_qθvsg (corresponding to the above-described corrected q-axis current command value I′ref_q), which is a qθvsg axis component of the internal-phase-synchronized dq coordinate system.

In the case of the third inverse transformation, the command value inverse transformation unit 444 derives the corrected d-axis current command value I′ref_d having the internal phase θvsg and the corrected q-axis current command value I′ref_q having the internal phase θvsg with the following Formula (5).

$$\begin{matrix}[ Mathematical Formula 12 ] & \\ ( \begin{matrix}{I}_{ref \_ d}^{′} \\ {I}_{ref \_ q}^{′}\end{matrix} ) = \frac{1}{\sqrt{{V}_{gd}^{2} + {V}_{gq}^{2}}} ( \begin{matrix}{V}_{gd} & - {V}_{gq} \\ {V}_{gq} & {V}_{gd}\end{matrix} ) ( \begin{matrix}{I}_{ref \_ d ( 3 )} \\ {I}_{ref \_ q ( 3 )}\end{matrix} ) & ( 5 )\end{matrix}$$

### (b5) Switching Controller

The switching controller 45 derives switching control signals g1 to g6 for performing switching control on the inverter 11 so as to output currents corresponding to the corrected d-axis current command value I′ref_d and the corrected q-axis current command value I′ref_q to the output line 12 of the inverter 11.

The switching controller 45 includes a current controller 451, an inverse dq transformation unit 452, a gain unit 453, and a PWM unit 454.

The current controller 451 performs current control based on the d-axis inverter current Iinv_d, the q-axis inverter current Iinv_q, the corrected d-axis current command value I′ref_d, and the corrected q-axis current command value I′ref_q to derive a d-axis inverter voltage command value Vinv_ref_d and a q-axis inverter voltage command value Vinv_ref_q. The current control is feedback control for outputting desired output currents Iga, Igb, and Igc in the first to third output lines 12a to 12c. Examples of the current control include PID control.

The inverse dq transformation unit 452 performs inverse dq transformation on the d-axis inverter voltage command value Vinv_ref_d and the q-axis inverter voltage command value Vinv_ref_q using the internal phase θvsg. The inverter voltage command values Vinv_ref_a, Vinv_ref_b, and Vinv_ref_c of the respective phases (phase a, phase b, phase c) to be output to the output line 12 of the inverter 11 are derived in the gain unit 453 by multiplying the fourth gain K4 by the values obtained through the inverse dq transformation.

The inverter voltage command values Vinv_ref_a, Vinv_ref_b, and Vinv_ref_c of the respective phases are expressed by, for example, the following Formula (15).

$$\begin{matrix}[ Mathematical Formula 13 ] & \\ ( \begin{matrix}{V}_{inv \_ ref \_ a} \\ {V}_{inv \_ ref \_ b} \\ {V}_{inv \_ ref \_ c}\end{matrix} ) = \sqrt{\frac{2}{3}} \frac{1}{k} ( \begin{matrix}cos ( {θ}_{ref} - {θ}_{0} ) & - sin ( {θ}_{ref} - {θ}_{0} ) \\ cos ( {θ}_{ref} - {θ}_{0} - \frac{2 π}{3} ) & - sin ( {θ}_{ref} - {θ}_{0} - \frac{2 π}{3} ) \\ cos ( {θ}_{ref} - {θ}_{0} + \frac{2 π}{3} ) & - sin ( {θ}_{ref} - {θ}_{0} + \frac{2 π}{3} )\end{matrix} ) ( \begin{matrix}{V}_{inv \_ ref \_ d} \\ {V}_{inv \_ ref \_ q}\end{matrix} ) & ( 15 )\end{matrix}$$

Here, the constant k is a free-selected positive real number, and θ0 is a constant of a real number.

As in Formula (6), θref in Formula (15) is the reference phase θref.

In the present embodiment, the inverter voltage command values Vinv_ref_a, Vinv_ref_b, and Vinv_ref_c are derived from the following Formula (15) with k=1, θ0=0 rad, and reference phase θref=internal phase θvsg in Formula (16).

$$[ Mathematical Formula 14 ]$$

$$( \begin{matrix}{V}_{inv \_ ref \_ a} \\ {V}_{inv \_ ref \_ b} \\ {V}_{inv \_ ref \_ c}\end{matrix} ) = \sqrt{\frac{2}{3}} ( \begin{matrix}cos ( {θ}_{vsg} ) & − sin ( {θ}_{vsg} ) \\ cos ( {θ}_{vsg} − \frac{2 π}{3} ) & − sin ( {θ}_{vsg} − \frac{2 π}{3} ) \\ cos ( {θ}_{vsg} + \frac{2 π}{3} ) & − sin ( {θ}_{vsg} + \frac{2 π}{3} )\end{matrix} ) ( {{V}_{inv \_ ref \_ d} \atop {V}_{inv \_ ref \_ q}} ) \qquad ( 16 )$$

The PWM unit 454 generates the switching control signals g1 to g6 by performing PWM control on the inverter voltage command values Vinv_ref_a, Vinv_ref_b, and Vinv_ref_c of the respective phases.

The switching control signals g1 to g6 thus generated are input to the gates G1 to G6 of the six first to sixth transistors T1 to T6 of the inverter 11. The inverter 11 controlled by the switching control signals g1 to g6 converts DC power of the DC power source 2 into AC power. In this case, since the active power and the reactive power in the AC power are in a state of being subjected to desired limits at different ratios, stability of the grid frequency and the grid voltage of the grid 4 can be secured.

### 2. Action and Effect

According to the present embodiment, the power conversion device 3 capable of limiting the active power and the reactive power at different ratios can be provided. According to the power conversion device 3, stability of the grid frequency and the grid voltage of the grid 4 can be secured. This will be specifically described below.

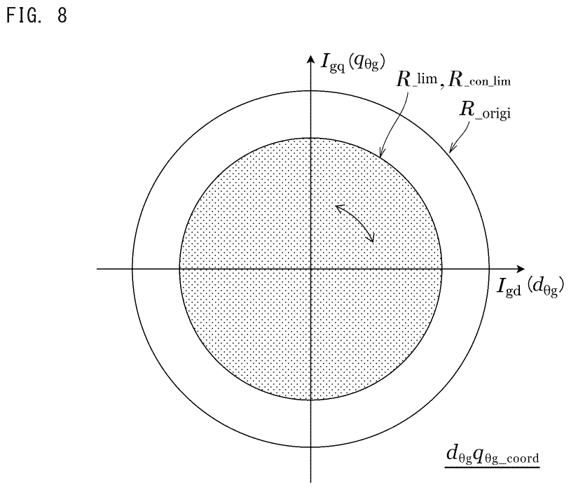

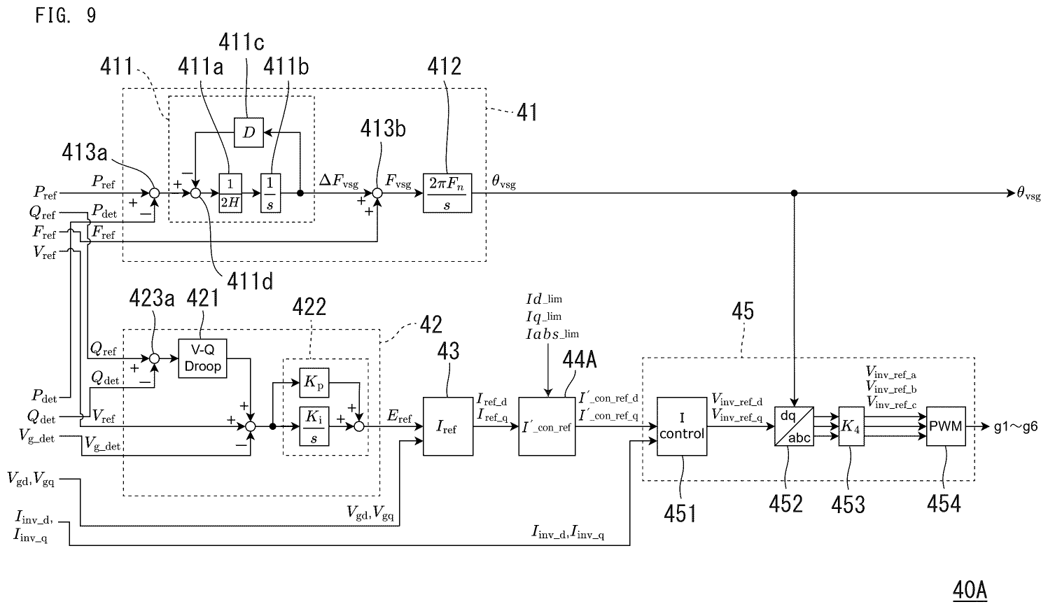

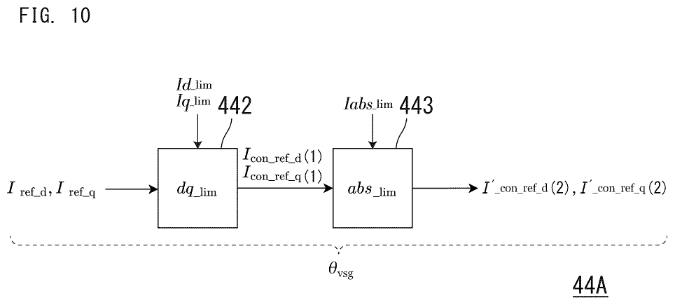

FIG. 8 is a schematic diagram illustrating ranges of active power and reactive power on grid-phase-synchronized dq coordinate system after multiplying a d-axis current command value and a q-axis current command value by a current absolute value limit value. FIG. 9 is a configuration diagram of the control signal derivation unit that does not perform correction on the d-axis current command value and the q-axis current command value in consideration of the phase difference between an internal phase and a grid phase. FIG. 10 is a configuration diagram of the current command value correction unit in FIG. 9. FIG. 11 is a schematic diagram illustrating ranges of active power and reactive power obtained by the control signal derivation unit in FIG. 9 on a grid-phase-synchronized dq coordinate system and ranges of active power and reactive power obtained by the control signal derivation unit according to the present embodiment on the grid-phase-synchronized dq coordinate system. FIG. 12 is a schematic diagram illustrating ranges of active power and reactive power obtained by the control signal derivation unit according to the present embodiment on a grid-phase-synchronized dq coordinate system.

In the above embodiment, transformation and inverse transformation in consideration of the phase difference between the internal phase θvsg and the grid phase θg are performed on the current command values (the d-axis current command value and the q-axis current command value). Specifically, the current command value having the internal phase θvsg is transformed into the current command value having the grid phase θg. Further, after the current command value having the grid phase θg is limited, the current command value having the grid phase θg after the limitation is inversely transformed into the current command value having the internal phase θvsg. Hereinafter, the current command value “with transformation” means a current command value subjected to transformation and inverse transformation in consideration of the phase difference between the internal phase θvsg and the grid phase θg. The range “with transformation” means a range of the active power and the reactive power on the dq coordinate system calculated based on the current command value “with transformation”. On the other hand, the current command value “without transformation” means a current command value for which transformation and inverse transformation in consideration of the phase difference between the internal phase θvsg and the grid phase θg have not been performed. The range “without transformation” means a range of the active power and the reactive power on the dq coordinate system calculated based on the current command value “without transformation”.

First, a case where both the active power and the reactive power are limited at the same ratio will be described. In the virtual synchronous generator control simulating the current control type virtual synchronous generator, when both the active power and the reactive power are limited at the same ratio, the power conversion device 3 normally multiplies the current command value having the internal phase θvsg before the limitation by the current absolute value limit value. The current absolute value limit value is 0 or more. Specifically, the d-axis current command value “without transformation” after the limitation is obtained by multiplying the d-axis current command value before the limitation by the current absolute value limit value. The q-axis current command value “without transformation” after the limitation is obtained by the q-axis current command value before the limitation by the current absolute value limit value. For example, as illustrated in FIG. 8, the active power and the reactive power before the limitation are indicated by a circular range R_origi before the limitation on the grid-phase-synchronized dq coordinate system. The range R_origi before the limitation is calculated based on the d-axis current command value before the limitation and the q-axis current command value before the limitation. In addition, the active power “without transformation” after the limitation and the reactive power “without transformation” after the limitation are indicated by a range R_con_lim “without transformation” after the circular limitation on the grid-phase-synchronized dq coordinate system. The range R_con_lim “without transformation” after the limitation is calculated based on the d-axis current command value “without transformation” after the limitation and the q-axis current command value “without transformation” after the limitation. As illustrated in FIG. 8, the range R_origi before the limitation is limited to the range R_con_lim “without transformation” after the limitation. The ratio of the limitation from the dog axis component of the range R_origi before the limitation to the deg axis component of the range R_con_lim “without transformation” after the limitation is the same as the ratio of the limitation from the qθg axis component of the range R_origi before the limitation to the qθg axis component of the range R_con_lim “without transformation” after the limitation. That is, the range R_origi before the limitation and the range R_con_lim “without transformation” after the limitation are in a concentric relationship around the intersection of the dog axis and the qθg axis.

Here, the internal phase θvsg and the grid phase θg may be shifted from each other. When the internal phase θvsg and the grid phase θg are shifted from each other, and the active power “without transformation” after the limitation and the reactive power “without transformation” after the limitation are supplied to the grid 4, at least one of the active power and the reactive power cannot be limited to a desired magnitude in the grid 4 in some cases.

However, in the example of FIG. 8, the power conversion device 3 multiplies both the d-axis current command value having the internal phase θvsg before the limitation and the q-axis current command value having the internal phase θvsg before the limitation by the current absolute value limit value. In this case, even when the internal phase θvsg and the grid phase θg are shifted from each other, the active power and the reactive power can be limited to desired magnitudes in the grid 4 even though the active power “without transformation” after the limitation and the reactive power “without transformation” after the limitation are output to the grid 4 in a state where the correction is not performed according to the phase difference between the internal phase θvsg and the grid phase θg. More specifically, as described above, as illustrated in FIG. 8, the active power “without transformation” after the limitation and the reactive power “without transformation” after the limitation are indicated by a range R_con_lim “without transformation” after the circular limitation on the grid-phase-synchronized dq coordinate system. Here, on the grid-phase-synchronized dq coordinate system, the range R_lim “with transformation” after the limitation is obtained by rotating the range R_con_lim “without transformation” after the limitation around the intersection of the dog axis and the qθg axis so as to correct the phase difference between the internal phase θvsg and the grid phase θg. The range R_con_lim “without transformation” after the limitation is circular on the grid-phase-synchronized dq coordinate system. Thus, even though the range R_con_lim “without transformation” after the limitation is rotated by the phase difference between the internal phase θvsg and the grid phase θg, the range R_lim “with transformation” after the limitation is the same as the range R_con_lim “without transformation” after the limitation. That is, the active power and the reactive power are limited to desired magnitudes in the grid 4 even though the active power and the reactive power defined by the range R_con_lim “without transformation” after the limitation are supplied to the grid 4 controlled by the grid phase θg in a state where the internal phase θvsg and the grid phase θg are shifted from each other.

Next, a case where each of the active power and the reactive power is limited at different ratios will be described. In this case, when the internal phase θvsg and the grid phase θg are shifted from each other, and the active power “without transformation” after the limitation and the reactive power “without transformation” after the limitation are supplied to the grid 4, at least one of the active power and the reactive power cannot be limited to a desired magnitude in the grid 4 in some cases.

A case where at least one of the active power and the reactive power cannot be limited to a desired magnitude in the grid 4 will be described with reference to FIGS. 9 and 10 as an example. As illustrated in FIG. 9, the control signal derivation unit 40A includes the internal phase derivation unit 41, the AVR unit 42, the current command value derivation unit 43, a current command value correction unit 44A, and the switching controller 45. As illustrated in FIG. 10, the current command value correction unit 44A includes the current limiting unit 442 and the absolute value limiting unit 443. While the current command value correction unit 44 illustrated in FIGS. 5 and 7 according to the present embodiment includes the command value transformation unit 441 and the command value inverse transformation unit 444, the current command value correction unit 44A illustrated in FIGS. 9 and 10 does not include the command value transformation unit 441 or the command value inverse transformation unit 444.

The current limiting unit 442 in FIG. 10 derives a first d-axis current command value Icon_ref_d(1) “without transformation” and a first q-axis current command value Icon_ref_q(1) “without transformation” by using the d-axis current limit value Id_lim, the q-axis current limit value Iq_lim, the d-axis current command value Iref_d having the internal phase θvsg, and the q-axis current command value Iref_q having the internal phase θvsg. Specifically, the first d-axis current command value Icon_ref_d(1) “without transformation” is obtained by multiplying the d-axis current command value Iref_d by the d-axis current limit value Id_lim. The first q-axis current command value Icon_ref_q(1) “without transformation” is obtained by multiplying the q-axis current command value Iref_q by the q-axis current limit value Iq_lim. The first d-axis current command value Icon_ref_d(1) “without transformation” and the first q-axis current command value Icon_ref_q(1) “without transformation” are not transformed by the command value transformation unit 441 illustrated in FIGS. 5 and 7 in consideration of the phase difference between the internal phase θvsg and the grid phase θg. Thus, the first d-axis current command value Icon_ref_d(1) “without transformation” and the first q-axis current command value Icon_ref_q(1) “without transformation” have the internal phase θvsg. The d-axis current limit value Id_lim and the q-axis current limit value Iq_lim are input from the outside to the current limiting unit 442 (a part of the inverter controller 20). Each of the d-axis current limit value Id_lim and the q-axis current limit value Iq_lim is a value of 0 or more, and the d-axis current limit value Id_lim and the q-axis current limit value Iq_lim are different values.

The absolute value limiting unit 443 derives the second d-axis current command value I′con_ref_d(2) “without transformation” and the second q-axis current command value I′con_ref_q(2) “without transformation” by using the current absolute value limit value Iabs_lim input to the absolute value limiting unit 443 (a part of the inverter controller 20) from the outside, the first d-axis current command value Icon_ref_d(1) “without transformation”, and the first q-axis current command value Icon_ref_q(1) “without transformation”. Specifically, the second d-axis current command value I′con_ref_d(2) “without transformation” is obtained by multiplying the first d-axis current command value Icon_ref_d(1) “without transformation” by the current absolute value limit value Iabs_lim. The second q-axis current command value I′con_ref_q(2) “without transformation” is obtained by multiplying the first q-axis current command value Icon_ref_q(1) “without transformation” by the current absolute value limit value Iabs_lim. The second d-axis current command value I′con_ref_d(2) “without transformation” and the second q-axis current command value I′con_ref_q(2) “without transformation” have the internal phase θvsg.

Based on the second d-axis current command value I′con_ref_d(2) “without transformation” and the second q-axis current command value I′con_ref_q(2) “without transformation”, the range R_con_lim “without transformation” of the active power and the reactive power is determined. In FIG. 11, the range R_con_lim “without transformation” is indicated on the grid-phase-synchronized dq coordinate system. Although the grid-phase-synchronized dq coordinate system is illustrated in FIG. 11, the dθvsg axis and the qθsg axis of the internal-phase-synchronized dq coordinate system illustrated in FIG. 2 are illustrated together for reference. In FIG. 11, the d-axis current limit value Id_lim is set to 1.0, and the q-axis current limit value Iq_lim is set to 0.5. The range R_con_lim “without transformation” is a region surrounded by the straight line α1 and the straight line β1 in the range R_origi before the circular limitation on the grid-phase-synchronized dq coordinate system. FIG. 11 further illustrates the range R_lim “with transformation” according to the present embodiment. The range R_lim “with transformation” is a range of the active power and the reactive power obtained based on the corrected d-axis current command value I′ref_d and the corrected q-axis current command value I′ref_q described above. The corrected d-axis current command value I′ref_d and the corrected q-axis current command value I′ref_q are current command values subjected to transformation and inverse transformation in consideration of the phase difference between the internal phase θvsg and the grid phase θg. The range R_lim “with transformation” is a region surrounded by the straight line α0 and the straight line β0 in the range R_origi before the circular limitation on the grid-phase-synchronized dq coordinate system.

The range R_lim “with transformation” coincides when the range R_con_lim “without transformation” is rotated (transformed) around the intersection O of the dog axis and the qθg axis by the phase difference between the internal phase θvsg and the grid phase θg. In the present embodiment, the phase difference is φvsg (=θvsg−θg). The phase difference corresponds to δ in FIG. 2. In other words, the range R_con_lim “without transformation” is shifted to a position corresponding to the phase difference (φvsg) between the internal phase θvsg and the grid phase θg with respect to the range R_lim “with transformation” around the intersection O of the dog axis and the qθg axis.

Here, the grid phase φg with reference to the reference phase θref and the internal phase φvsg with reference to the reference phase θref are expressed by the following Formulas (17-1) and (17-2), respectively. In the grid-phase-synchronized dq coordinate system of FIGS. 11 and 12, the reference phase θref=the grid phase θg is satisfied. Thus, the following Formulas (17-1) and (17-2) are the following Formulas (17-3) and (17-4) in the grid-phase-synchronized dq coordinate system of FIGS. 11 and 12.

$$φ g = θ g - θ ref \qquad ( 17 - 1 )$$

$$φ vsg = θ vsg - θ ref \qquad ( 17 - 2 )$$

$$φ g = θ g - θ ref = θ g - θ g = 0 \qquad ( 17 - 3 )$$

$$φ vsg = θ vsg - θ ref = θ vsg - θ g = δ \qquad ( 17 - 4 )$$

Next, the straight lines α1 and β1 defining the range R_con_lim “without transformation” and the straight lines α0 and β0 defining the range R_lim “with transformation” are also described below. As described above, it is assumed that the d-axis current limit value Id_lim is 1.0, and the q-axis current limit value Iq_lim is 0.5. The straight line α1 passes through a portion corresponding to the q-axis current limit value Iq_lim=0.5 in the positive region of the q-axis current Igq on the qθg axis. The straight line α1 is inclined with respect to the straight line α0 around the intersection O by the phase difference φvsg (=8) between the internal phase θvsg and the grid phase θg. The straight line α0 is a horizontal straight line passing through the portion corresponding to the q-axis current limit value Iq_lim=0.5 in the positive region of the qθg axis and extending along the dog axis. In the example of FIG. 11, the straight line α1 is inclined upward to the right with respect to the straight line α0. On the other hand, the straight line β1 passes through a portion corresponding to the q-axis current limit value-Iq_lim=−0.5 in the negative region of the qθg axis. The straight line β1 is inclined with respect to the straight line β0 around the intersection O by the phase difference φvsg (=8) between the internal phase θvsg and the grid phase θg. The straight line β0 is a horizontal straight line passing through the portion corresponding to the q-axis current limit value-Iq_lim=−0.5 in the negative region of the qθg axis and extending along the dog axis. In the example of FIG. 11, the straight line β1 is inclined upward to the right with respect to the straight line β0.

In this manner, the range R_con_lim “without transformation” determined by the straight lines α1 and β1 is shifted by the phase difference φvsg (=8) between the internal phase θvsg and the grid phase θg with respect to the range R_lim “with transformation” determined by the straight lines α0 and β0. Thus, when the active power and the reactive power specified in the range R_con_lim “without transformation” are output to the grid 4 controlled with the grid phase θg, at least one of the active power and the reactive power cannot be limited to a desired magnitude in the grid 4 in some cases. In the case of the example of FIG. 11, the q-axis components of the active power and the reactive power are output to the grid 4 without being limited by a desired limit (q-axis current limit value±Iq_lim=+0.5). Specifically, when the q-axis components of the active power and the reactive power are output to the grid 4 in the region γ1 exceeding the straight line α0 in the range R_con_lim “without transformation” (region γ1 surrounded by the straight line α0 and the straight line α1 in the range R_con_lim “without transformation”), the q-axis components of the active power and the reactive power are not limited to desired magnitudes. In the region γ2 (region γ2 surrounded by the straight line β0 and the straight line β1 in the range R_con_lim “without transformation”) exceeding the straight line β0 in the range R_con_lim “without transformation”, when the q-axis components of the active power and the reactive power are output to the grid 4, the q-axis components are not limited to desired magnitudes.

In the example of FIG. 11, since the d-axis current limit value±Id_lim=+1.0 is satisfied, the d-axis components of the active power and the reactive power are not limited. However, with the d-axis current limit value±Id_lim set to less than +1.0, the d-axis components are not limited to desired magnitudes when the d-axis components of the active power and the reactive power are output to the grid 4 as described above.

Further, in a region γ3 exceeding the straight line α1 in the range R_lim “with transformation” (region γ3 surrounded by the straight line α0 and the straight line α1 in the range R_lim “with transformation”), when the q-axis components of the active power and the reactive power are output to the grid 4, the q-axis components are excessively limited beyond a desired limit (here, the q-axis current limit value Iq_lim=0.5). In a region γ4 exceeding the straight line β1 in the range R_lim “with transformation” (region γ4 surrounded by the straight line β0 and the straight line β1 in the range R_lim “with transformation”), when the q-axis components of the active power and the reactive power are output to the grid 4, the q-axis components are excessively limited beyond a desired limit (here, the q-axis current limit value-Iq_lim=−0.5).

The above configuration according to the present embodiment can limit the active power and the reactive power to desired magnitudes in the grid 4 even when the active power and the reactive power are limited at different ratios in a state where the internal phase θvsg and the grid phase θg are shifted from each other because the power conversion device 3 includes the current command value correction unit 44. A brief description will be given below.

The current command value correction unit 44 transforms, limits, and inversely transforms each of the d-axis current command value Iref_d and the q-axis current command value Iref_q in consideration of the phase difference φvsg (=δ) between the internal phase θvsg and the grid phase θg. The current command value correction unit 44 includes the command value transformation unit 441, the current limiting unit 442, the absolute value limiting unit 443, and the command value inverse transformation unit 444.

The d-axis current command value Iref_d and the q-axis current command value Iref_q have the internal phase θvsg and are shifted from the grid phase θg. In consideration of the phase difference φvsg (=δ) between the internal phase θvsg and the grid phase θg, the command value transformation unit 441 transforms the d-axis current command value Iref_d having the internal phase θvsg and the q-axis current command value Iref_q having the internal phase θvsg into the first d-axis current command value Iref_d(1) having the grid phase θg and the first q-axis current command value Iref_q(1) having the grid phase θg, respectively.

Next, the current limiting unit 442 limits the first d-axis current command value Iref_d(1) having the grid phase θg and the first q-axis current command value Iref_q(1) having the grid phase θg with the d-axis current limit value Id_lim and the q-axis current limit value Iq_lim respectively, and derives the second d-axis current command value Iref_d(2) having the grid phase θg and the second q-axis current command value Iref_q(2) having the grid phase θg.

Next, the absolute value limiting unit 443 derives the third d-axis current command value Iref_d(3) having the grid phase θg and the third q-axis current command value Iref_q(3) having the grid phase θg by commonly multiplying the second d-axis current command value Iref_d(2) having the grid phase θg and the second q-axis current command value Iref_q(2) having the grid phase θg by the current absolute value limit value Iabs_lim. Through the processing with the absolute value limiting unit 443, the voltage and the current flowing through the inverter 11 can be prevented from becoming too large. Thus, malfunction, destruction, and the like of elements and the like constituting the inverter 11 can be suppressed.

Next, the command value inverse transformation unit 444 inversely transforms the third d-axis current command value Iref_d(3) having the grid phase θg and the third q-axis current command value Iref_q(3) having the grid phase θg into the corrected d-axis current command value I′ref_d having the internal phase θvsg and the corrected q-axis current command value I′ref_q having the internal phase θvsg in consideration of the phase difference φvsg (=8).

The switching controller 45 performs switching control on the inverter 11 using the switching control signals g1 to g6 corresponding to the corrected d-axis current command value I′ref_d and the corrected q-axis current command value I′ref_q.

With such a configuration, in a state where the internal phase θvsg and the grid phase θg are shifted from each other, the active power and the reactive power can be limited to desired magnitudes in the grid 4 even though the active power and the reactive power are respectively limited at different ratios.

FIG. 12 illustrates the range R_lim “with transformation” of the active power and the reactive power in FIG. 11. As illustrated in FIG. 12, the active power and the reactive power defined by the range R_lim “with transformation” do not have a phase difference from the grid phase θg on the grid-phase-synchronized dq coordinate system, and the active power and the reactive power are synchronized with the grid phase θg. Thus, the active power and the reactive power defined by the range R_lim “with transformation” are limited to desired magnitudes when output to the grid 4.

The embodiment of the present invention has been disclosed herein by the above description, but the present invention is not limited to this embodiment.

The above-described embodiment may be modified in various forms in terms of mechanism, shape, material, quantity, position, arrangement, etc., without departing from the scope of the technical idea and object of the present invention, and such modifications are included in the present invention.

### 3. Modification

### <A>

In the above embodiment, the current command value correction unit 44 is configured to be able to limit both the d-axis current command value Iref_d and the q-axis current command value Iref_q.

(a) Limitation on Only q-Axis Current Command Value

However, unlike the above embodiment, the current command value correction unit 44 may be configured to be able to limit only to the q-axis current command value Iref_q. Specifically, similarly to the above embodiment, the command value transformation unit 441 transforms the d-axis current command value Iref_d having the internal phase θvsg and the q-axis current command value Iref_q having the internal phase θvsg into the first d-axis current command value Iref_d(1) having the grid phase θg and the first q-axis current command value Iref_q(1) having the grid phase θg, respectively. The current limiting unit 442 multiplies by the q-axis current limit value Iq_lim only on the first q-axis current command value Iref_q(1). On the other hand, the current limiting unit 442 does not multiply by the d-axis current limit value Id_lim on the first d-axis current command value Iref_d(1). In other words, the q-axis current limit value Iq_lim is 0 or more, and the d-axis current limit value Id_lim is 1.0. In this case, the current limiting unit 442 derives the second d-axis current command value Iref_d(2) having the grid phase θg and the second q-axis current command value Iref_q(2) having the grid phase θg from the following Formula (18).

$$[ Mathematical Formula 15 ]$$

$$( \begin{matrix}{I}_{ref \_ d ( 2 )} \\ {I}_{ref \_ q ( 2 )}\end{matrix} ) = ( \begin{matrix}{I}_{ref \_ d ( 1 )} \\ Max ( Min \{ {I}_{ref \_ q ( 1 )} , {I}_{q \_ lim} ) , - {I}_{q \_ lim} )\end{matrix} ) \qquad ( 18 )$$

Derivation of the third d-axis current command value Iref_d(3) and the third q-axis current command value Iref_q(3) with the absolute value limiting unit 443 in the present modification is expressed by a formula obtained by substituting the second d-axis current command value Iref_d(2) and the second q-axis current command value Iref_q(2) of Formula (18) into Formula (4) of the above-described embodiment. Derivation of the corrected d-axis current command value I′ref_d and the corrected q-axis current command value I′ref_q with the command value inverse transformation unit 444 in the present modification is expressed by a formula obtained by substituting the third d-axis current command value Iref_d(3) and the third q-axis current command value Iref_q(3) derived in the present modification into Formula (5) in the above-described embodiment.

(b) Limitation on Only d-Axis Current Command Value

Further, unlike the above embodiment, the current command value correction unit 44 may be configured to be able to limit only to the d-axis current command value Iref_d. Specifically, similarly to the above embodiment, the command value transformation unit 441 transforms the d-axis current command value Iref_d having the internal phase θvsg and the q-axis current command value Iref_q having the internal phase θvsg into the first d-axis current command value Iref_d(1) having the grid phase θg and the first q-axis current command value Iref_q(1) having the grid phase θg, respectively. The current limiting unit 442 multiplies by the d-axis current limit value Id_lim only on the first d-axis current command value Iref_d(1). On the other hand, the current limiting unit 442 does not multiply by the q-axis current limit value Iq_lim on the first q-axis current command value Iref_q(1). In other words, the d-axis current limit value Id_lim is 0 or more, and the q-axis current limit value Iq_lim is 1.0. In this case, the current limiting unit 442 derives the second d-axis current command value Iref_d(2) having the grid phase θg and the second q-axis current command value Iref_q(2) having the grid phase θg from the following Formula (19).

$$[ Mathematical Formula 16 ]$$

$$( \begin{matrix}{I}_{ref \_ d ( 2 )} \\ {I}_{ref \_ q ( 2 )}\end{matrix} ) = ( \begin{matrix}Max ( Min \{ {I}_{ref \_ d ( 1 )} , {I}_{d \_ lim} ) , - {I}_{d \_ lim} ) \\ {I}_{ref \_ q ( 1 )}\end{matrix} ) \qquad ( 19 )$$

Derivation of the third d-axis current command value Iref_d(3) and the third q-axis current command value Iref_q(3) with the absolute value limiting unit 443 in the present modification is expressed by a formula obtained by substituting the second d-axis current command value Iref_d(2) and the second q-axis current command value Iref_q(2) of Formula (19) into Formula (4) of the above-described embodiment. Derivation of the corrected d-axis current command value I′ref_d and the corrected q-axis current command value I′ref_q with the command value inverse transformation unit 444 in the present modification is expressed by a formula obtained by substituting the third d-axis current command value Iref_d(3) and the third q-axis current command value Iref_q(3) derived in the present modification into Formula (5) in the above-described embodiment.

### <B>

In the above embodiment, the current command value correction unit 44 includes the absolute value limiting unit 443. However, when the magnitudes of the active power and the reactive power do not exceed predetermined ranges, the absolute value limiting unit 443 can be omitted. In this case, the current command value correction unit 44 includes the command value transformation unit 441, the current limiting unit 442, and the command value inverse transformation unit 444. Then, similarly to the above embodiment, the command value transformation unit 441 transforms the d-axis current command value Iref_d having the internal phase θvsg and the q-axis current command value Iref_q having the internal phase θvsg into the first d-axis current command value Iref_d(1) having the grid phase θg and the first q-axis current command value Iref_q(1) having the grid phase θg, respectively. Similarly to the above embodiment, the current limiting unit 442 derives the second d-axis current command value Iref_d(2) having the grid phase θg and the second q-axis current command value Iref_q(2) having the grid phase θg by limiting the first d-axis current command value Iref_d(1) and the first q-axis current command value Iref_q(1), respectively.

Thereafter, the command value inverse transformation unit 444 inversely transforms the second d-axis current command value Iref_d(2) having the grid phase θg and the second q-axis current command value Iref_q(2) having the grid phase θg into the corrected d-axis current command value I′ref_d having the internal phase θvsg and the corrected q-axis current command value I′ref_q having the internal phase θvsg, respectively.

In the case of the first inverse transformation, the command value inverse transformation unit 444 inversely coordinate-transforms the coordinate points of the second d-axis current command value Iref_d(2) and the coordinate points of the second q-axis current command value Iref_q(2) on the grid-phase-synchronized dq coordinate system into coordinate points of the corrected d-axis current command value I′ref_d and coordinate points of the corrected q-axis current command value I′ref_q on the internal-phase-synchronized dq coordinate system, respectively.

In the case of the second inverse transformation, the command value inverse transformation unit 444 performs inverse rotational transformation on the rotationally transformed grid-phase-synchronized dq coordinate system in the command value transformation unit 441 from the grid phase θg to the internal phase θvsg, thereby inversely transforming the grid-phase-synchronized dq coordinate system into the internal-phase-synchronized dq coordinate system. Thus, the command value inverse transformation unit 444 inversely transforms the second d-axis current command value Iref_d(2) having the grid phase θg and the second q-axis current command value Iref_q(2) having the grid phase θg into the corrected d-axis current command value I′ref_d having the internal phase θvsg and the corrected q-axis current command value I′ref_q having the internal phase θvsg, respectively.

In the case of the third inverse transformation, the command value inverse transformation unit 444 derives the corrected d-axis current command value I′ref_d having the internal phase θvsg and the corrected q-axis current command value I′ref_q having the internal phase θvsg with the following Formula (3).

$$[ Mathematical Formula 17 ]$$

$$( \begin{matrix}{I}_{ref \_ d}^{′} \\ {I}_{ref \_ q}^{′}\end{matrix} ) = \frac{1}{\sqrt{{V}_{gd}^{2} + {V}_{gq}^{2}}} ( \begin{matrix}{V}_{gd} & - {V}_{gq} \\ {V}_{gq} & {V}_{gd}\end{matrix} ) ( \begin{matrix}{I}_{ref \_ d ( 2 )} \\ {I}_{ref \_ q ( 2 )}\end{matrix} ) \qquad ( 3 )$$

### <C>

In the above embodiment, the d-axis inverter current Iinv_d and the q-axis inverter current Iinv_q are input to the switching controller 45. However, instead of the d-axis inverter current Iinv_d and the q-axis inverter current Iinv_q, the d-axis current Igd and the q-axis current Igq may be input to the switching controller 45.

In this case, the current controller 451 performs current control based on the d-axis current Igd, the q-axis current Igq, the corrected d-axis current command value I′ref_d, and the corrected q-axis current command value I′ref_q to derive the d-axis voltage command value Vref_d and the q-axis voltage command value Vref_q.

The inverse dq transformation unit 452 performs inverse dq transformation on the d-axis voltage command value Vref_d and the q-axis voltage command value Vref_q using the internal phase θvsg. By multiplying the fourth gain K4 to the values obtained through the inverse dq transformation with the gain unit 453, the voltage command values Vref_a, Vref_b, and Vref_c of the respective phases (phase a, phase b, phase c) to be output to the output line 12 of the inverter 11 are derived.

Derivation of the voltage command values Vref_a, Vref_b, and Vref_c of the respective phases is expressed by, for example, the following Formula (20).

$$[ Mathematical Formula 18 ]$$

$$( \begin{matrix}{V}_{ref \_ a} \\ {V}_{ref \_ b} \\ {V}_{ref \_ c}\end{matrix} ) = \sqrt{\frac{2}{3}} \frac{1}{k} ( \begin{matrix}cos ( {θ}_{ref} - {θ}_{0} ) & − sin ( {θ}_{ref} - {θ}_{0} ) \\ cos ( {θ}_{ref} − {θ}_{0} - \frac{2 π}{3} ) & − sin ( {θ}_{ref} − {θ}_{0} - \frac{2 π}{3} ) \\ cos ( {θ}_{ref} - {θ}_{0} + \frac{2 π}{3} ) & − sin ( {θ}_{ref} − {θ}_{0} - \frac{2 π}{3} )\end{matrix} ) ( \begin{matrix}{V}_{ref \_ d} \\ {V}_{ref \_ q}\end{matrix} ) \qquad ( 20 )$$

Here, the constant k is a free-selected positive real number, and θ0 is a constant of a real number.

As in Formula (6), θref in Formula (20) is the reference phase θref.

In the present modification, the voltage command values Vref_a, Vref_b, and Vref_c are derived from the following Formula (21) with k=1, θ0=0 rad, and reference phase θref=internal phase θvsg in Formula (20).

$$[ Mathematical Formula 19 ]$$

$$( \begin{matrix}{V}_{ref \_ a} \\ {V}_{ref \_ b} \\ {V}_{ref \_ c}\end{matrix} ) = \sqrt{\frac{2}{3}} ( \begin{matrix}cos ( {θ}_{vsg} ) & − sin ( {θ}_{vsg} ) \\ cos ( {θ}_{vsg} - \frac{2 π}{3} ) & − sin ( {θ}_{vsg} - \frac{2 π}{3} ) \\ cos ( {θ}_{vsg} + \frac{2 π}{3} ) & − sin ( {θ}_{vsg} - \frac{2 π}{3} )\end{matrix} ) ( \begin{matrix}{V}_{ref \_ d} \\ {V}_{ref \_ q}\end{matrix} ) \qquad ( 21 )$$

The PWM unit 454 generates the switching control signals g1 to g6 by performing PWM control on the voltage command values Vref_a, Vref_b, and Vref_c of the respective phases.

### <D>

In the above embodiment, the grid 4 transmits AC power using a three-phase three-wire method. However, as long as the active power and the reactive power in the grid 4 can be limited to desired magnitudes in consideration of the phase difference between the internal phase θvsg and the grid phase θg as in the above-described embodiment, the power transmission method of the AC power in the grid 4 is not limited. For example, the idea of the present invention can also be applied to a power transmission method such as a single-phase three-wire method or a new power transmission method.

What is claimed is:

1. A power conversion device comprising:
an inverter that converts DC power of a DC power source into AC power and outputs the AC power to a grid via an output line; and
an inverter controller that controls the inverter to perform virtual synchronous generator control with a virtual synchronous generator simulating a synchronous generator, wherein
the inverter controller includes:
a dq transformation unit that derives a d-axis current, a d-axis voltage, a q-axis current, and a q-axis voltage on an internal-phase-synchronized dq coordinate system that rotates in synchronization with an internal phase of the virtual synchronous generator from an output voltage and an output current measured on an output line of the inverter, the d-axis current, the d-axis voltage, the q-axis current, and the q-axis voltage having the internal phase;
an internal phase derivation unit that derives an internal frequency deviation of the virtual synchronous generator from a deviation between active power derived from the d-axis current, the d-axis voltage, the q-axis current, and the q-axis voltage and an active power command value input from outside to the inverter controller, and derives the internal phase from the internal frequency deviation and an external frequency command value input from the outside to the inverter controller;
an AVR unit that derives an internal voltage of the virtual synchronous generator from reactive power derived from the d-axis current, the d-axis voltage, the q-axis current, and the q-axis voltage, a reactive power command value input from the outside to the inverter controller, an output voltage absolute value derived from the d-axis voltage and the q-axis voltage, and an external voltage command value input from the outside to the inverter controller, to perform automatic voltage control in the virtual synchronous generator;
a current command value derivation unit that derives a d-axis current command value having the internal phase and a q-axis current command value having the internal phase from the internal voltage, the d-axis voltage, the q-axis voltage, and an internal impedance of the virtual synchronous generator;
a current command value correction unit that transforms the d-axis current command value and the q-axis current command value into a first d-axis current command value and a first q-axis current command value, respectively, in consideration of a phase difference between the internal phase and a grid phase of the grid, and then derives a corrected d-axis current command value and a corrected q-axis current command value by using a value obtained by applying a limit to at least one of the first d-axis current command value and the first q-axis current command value; and
a switching controller that derives a switching control signal for performing switching control on the inverter to output a current corresponding to each of the corrected d-axis current command value and the corrected q-axis current command value to the output line of the inverter, and
the current command value correction unit includes:
a command value transformation unit that transforms the d-axis current command value having the internal phase and the q-axis current command value having the internal phase into the first d-axis current command value having the grid phase and the first q-axis current command value having the grid phase, respectively;
a current limiting unit that derives, using a d-axis current limit value and a q-axis current limit value input from the outside to the inverter controller to adjust each of the active power and the reactive power, the first d-axis current command value, and the first q-axis current command value, a second d-axis current command value having the grid phase by applying the d-axis current limit value to the first d-axis current command value and derives a second q-axis current command value having the grid phase by applying the q-axis current limit value to the first q-axis current command value, wherein the d-axis current limit value and the q-axis current limit value are different values of 0 or more; and
a command value inverse transformation unit that inversely transforms the second d-axis current command value having the grid phase and the second q-axis current command value having the grid phase into the corrected d-axis current command value having the internal phase and the corrected q-axis current command value having the internal phase, respectively.

2. The power conversion device according to claim 1, wherein
in the command value transformation unit, coordinate points of the d-axis current command value and coordinate points of the q-axis current command value on the internal-phase-synchronized dq coordinate system are coordinate-transformed into coordinate points of the first d-axis current command value and coordinate points of the first q-axis current command value on a grid-phase-synchronized dq coordinate system that rotates in synchronization with the grid phase, respectively, and
in the command value inverse transformation unit, coordinate points of the second d-axis current command value and coordinate points of the second q-axis current command value on the grid-phase-synchronized dq coordinate system are inversely coordinate-transformed into coordinate points of the corrected d-axis current command value and coordinate points of the corrected q-axis current command value on the internal-phase-synchronized dq coordinate system, respectively.

3. The power conversion device according to claim 1, wherein
in the command value transformation unit, the internal-phase-synchronized dq coordinate system is rotationally transformed from the internal phase to the grid phase to transform into a grid-phase-synchronized dq coordinate system that rotates in synchronization with the grid phase, and the d-axis current command value having the internal phase and the q-axis current command value having the internal phase are transformed into the first d-axis current command value having the grid phase and the first q-axis current command value having the grid phase, respectively, and
in the command value inverse transformation unit, the grid-phase-synchronized dq coordinate system that has been rotationally transformed in the command value transformation unit is inversely rotational-transformed from the grid phase to the internal phase to inversely transform into the internal-phase-synchronized dq coordinate system, and the second d-axis current command value having the grid phase and the second q-axis current command value having the grid phase are inversely transformed into the corrected d-axis current command value having the internal phase and the corrected q-axis current command value having the internal phase, respectively.

4. The power conversion device according to claim 1, wherein
derivation of the first d-axis current command value and the first q-axis current command value with the command value transformation unit is expressed by the following Formula (1):
$$[ Mathematical Formula 1 ]$$
$$( \begin{matrix}{I}_{ref \_ d ( 1 )} \\ {I}_{ref \_ q ( 1 )}\end{matrix} ) = \frac{1}{\sqrt{{V}_{g d}^{2} + {V}_{g q}^{2}}} ( \begin{matrix}{V}_{gd} & {V}_{gq} \\ - {V}_{gq} & {V}_{gd}\end{matrix} ) ( \begin{matrix}{I}_{ref \_ d} \\ {I}_{ref \_ q}\end{matrix} ) \qquad ( 1 )$$
wherein
Iref_d(1) is the first d-axis current command value,
Iref_q(1) is the first q-axis current command value,
Vgd is the d-axis voltage,
Vgq is the q-axis voltage,
Iref_d is the d-axis current command value, and
Iref_q is the q-axis current command value.

5. The power conversion device according to claim 4, wherein
derivation of the second d-axis current command value and the second q-axis current command value with the current limiting unit is expressed by the following Formula (2):
$$[ Mathematical Formula 2 ]$$
$$( \begin{matrix}{I}_{ref \_ d ( 2 )} \\ {I}_{ref \_ q ( 2 )}\end{matrix} ) = ( \begin{matrix}Max ( Min ( {I}_{ref \_ d ( 1 )} , {I}_{d \_ lím} ) , - {I}_{d \_ lím} ) \\ Max ( Min ( {I}_{ref \_ q ( 1 )} , {I}_{q \_ lím} ) , - {I}_{q \_ lim} )\end{matrix} ) \qquad ( 2 )$$
wherein
Iref_d(2) is the second d-axis current command value,
Iref_q(2) is the second q-axis current command value,
Id_lim is the d-axis current limit value, and
Iq_lim is the q-axis current limit value.

6. The power conversion device according to claim 5, wherein
derivation of the corrected d-axis current command value and the corrected q-axis current command value with the command value inverse transformation unit is expressed by the following Formula (3):
$$[ Mathematical Formula 3 ]$$
$$( \begin{matrix}{I}_{ref \_ d}^{′} \\ {I}_{ref \_ q}^{′}\end{matrix} ) = \frac{1}{\sqrt{{V}_{gd}^{2} + {V}_{gq}^{2}}} ( \begin{matrix}{V}_{gd} & - {V}_{gq} \\ {V}_{gq} & {V}_{gd}\end{matrix} ) ( \begin{matrix}{I}_{ref \_ d ( 2 )} \\ {I}_{ref \_ q ( 2 )}\end{matrix} ) \qquad ( 3 )$$
wherein
I′ref_d is the corrected d-axis current command value, and
I′ref_q is the corrected q-axis current command value.

7. The power conversion device according to claim 1, wherein
the current command value correction unit further includes
an absolute value limiting unit that derives, using a current absolute value limit value input from the outside to the inverter controller to commonly adjust the active power and the reactive power, the second d-axis current command value, and the second q-axis current command value, a third d-axis current command value having the grid phase by multiplying the second d-axis current command value by the current absolute value limit value and derives a third q-axis current command value having the grid phase by multiplying the second q-axis current command value by the current absolute value limit value, and
the command value inverse transformation unit inversely transforms, instead of the second d-axis current command value having the grid phase and the second q-axis current command value having the grid phase, the third d-axis current command value having the grid phase and the third q-axis current command value having the grid phase into the corrected d-axis current command value having the internal phase and the corrected q-axis current command value having the internal phase, respectively.

8. The power conversion device according to claim 5, wherein
the current command value correction unit further includes
an absolute value limiting unit that derives, using a current absolute value limit value input from the outside to the inverter controller to commonly adjust the active power and the reactive power, the second d-axis current command value, and the second q-axis current command value, a third d-axis current command value having the grid phase by multiplying the second d-axis current command value by the current absolute value limit value and derives a third q-axis current command value having the grid phase by multiplying the second q-axis current command value by the current absolute value limit value,
the command value inverse transformation unit inversely transforms, instead of the second d-axis current command value having the grid phase and the second q-axis current command value having the grid phase, the third d-axis current command value having the grid phase and the third q-axis current command value having the grid phase into the corrected d-axis current command value having the internal phase and the corrected q-axis current command value having the internal phase, respectively, and
derivation of the third d-axis current command value and the third q-axis current command value with the absolute value limiting unit is expressed by the following Formula (4), and derivation of the corrected d-axis current command value and the corrected q-axis current command value is expressed by the following Formula (5):
$$[ Mathematical Formula 4 ]$$
$$( \begin{matrix}{I}_{ref \_ d ( 3 )} \\ {I}_{ref \_ q ( 3 )}\end{matrix} ) = \frac{Min ( \sqrt{{( {I}_{ref \_ d ( 2 )} )}^{2} + {( {I}_{ref \_ q ( 2 )} )}^{2} ,} {I}_{abs \_ lim} )}{\sqrt{{( {I}_{ref \_ d ( 2 )} )}^{2} + {( {I}_{ref \_ q ( 2 )} )}^{2}}} ( \begin{matrix}{I}_{ref \_ d ( 2 )} \\ {I}_{ref \_ q ( 2 )}\end{matrix} ) \qquad ( 4 )$$
$$[ Mathematical Formula 5 ]$$
$$( \begin{matrix}{I}_{ref \_ d}^{′} \\ {I}_{ref \_ q}^{′}\end{matrix} ) = \frac{1}{\sqrt{{V}_{gd}^{2} + {V}_{gq}^{2}}} ( \begin{matrix}{V}_{gd} & - {V}_{gq} \\ {V}_{gq} & {V}_{gd}\end{matrix} ) ( \begin{matrix}{I}_{ref \_ d ( 3 )} \\ {I}_{ref \_ q ( 3 )}\end{matrix} ) \qquad ( 5 )$$
wherein
Iref_d(2) is the second d-axis current command value,
Iref_q(2) is the second q-axis current command value,
Iref_d(3) is the third d-axis current command value,
Iref_q(3) is the third q-axis current command value,
Iabs_lim is the current absolute value limit value,
I′ref_d is the corrected d-axis current command value,
I′ref_q is the corrected q-axis current command value,
Vgd is the d-axis voltage, and
Vgq is the q-axis voltage.

9. The power conversion device according to claim 1, wherein the internal phase derivation unit derives the internal frequency deviation by performing predetermined calculation processing using the deviation between the active power and the active power command value and an oscillation equation, derives a rated frequency of the virtual synchronous generator by adding the external frequency command value to the internal frequency deviation, and derives the internal phase by integrating an angular velocity based on the rated frequency of the virtual synchronous generator.

10. The power conversion device according to claim 1, wherein the AVR unit derives the internal voltage by performing predetermined calculation on the deviation between the reactive power and the reactive power command value based on a droop characteristic of AVR to give a first-order lag element to a calculation result, subtracting the output voltage absolute value from a sum of a result of giving the first-order lag element and the external voltage command value, and then performing feedback control.

11. The power conversion device according to claim 1, wherein the internal impedance is virtually simulated based on a winding resistance and a winding reactance of an armature of the virtual synchronous generator.

12. The power conversion device according to claim 1, wherein
the dq transformation unit derives a d-axis inverter current and a q-axis inverter current from an inverter output current measured at a position close to the inverter in the output line of the inverter, and
the switching controller includes:
a current controller that performs current control based on the d-axis inverter current, the q-axis inverter current, the corrected d-axis current command value, and the corrected q-axis current command value to derive a d-axis inverter voltage command value and a q-axis inverter voltage command value;
an inverse dq transformation unit that performs inverse dq transformation on the d-axis inverter voltage command value and the q-axis inverter voltage command value to derive an inverter voltage command value of each phase to be output to the output line of the inverter; and
a PWM unit that generates the switching control signal with PWM control from the inverter voltage command value of each phase.

13. The power conversion device according to claim 1, wherein
the switching controller includes:
a current controller that performs current control based on the d-axis current, the q-axis current, the corrected d-axis current command value, and the corrected q-axis current command value to derive a d-axis voltage command value and a q-axis voltage command value;
an inverse dq transformation unit that performs inverse dq transformation on the d-axis voltage command value and the q-axis voltage command value to derive a voltage command value of each phase to be output to the output line of the inverter; and
a PWM unit that generates the switching control signal with PWM control from the voltage command value of each phase.

14. The power conversion device according to claim 2, wherein
in the command value transformation unit, the internal-phase-synchronized dq coordinate system is rotationally transformed from the internal phase to the grid phase to transform into a grid-phase-synchronized dq coordinate system that rotates in synchronization with the grid phase, and the d-axis current command value having the internal phase and the q-axis current command value having the internal phase are transformed into the first d-axis current command value having the grid phase and the first q-axis current command value having the grid phase, respectively, and
in the command value inverse transformation unit, the grid-phase-synchronized dq coordinate system that has been rotationally transformed in the command value transformation unit is inversely rotational-transformed from the grid phase to the internal phase to inversely transform into the internal-phase-synchronized dq coordinate system, and the second d-axis current command value having the grid phase and the second q-axis current command value having the grid phase are inversely transformed into the corrected d-axis current command value having the internal phase and the corrected q-axis current command value having the internal phase, respectively.

15. The power conversion device according to claim 2, wherein
derivation of the first d-axis current command value and the first q-axis current command value with the command value transformation unit is expressed by the following Formula (1):
$$[ Mathematical Formula 1 ]$$
$$( \begin{matrix}{I}_{ref \_ d ( 1 )} \\ {I}_{ref \_ q ( 1 )}\end{matrix} ) = \frac{1}{\sqrt{{V}_{g d}^{2} + {V}_{g q}^{2}}} ( \begin{matrix}{V}_{gd} & {V}_{gq} \\ - {V}_{gq} & {V}_{gd}\end{matrix} ) ( \begin{matrix}{I}_{ref \_ d} \\ {I}_{ref \_ q}\end{matrix} ) \qquad ( 1 )$$
wherein
Iref_d(1) is the first d-axis current command value,
Iref_q(1) is the first q-axis current command value,
Vgd is the d-axis voltage,
Vgq is the q-axis voltage,
Iref_d is the d-axis current command value, and
Iref_q is the q-axis current command value.

16. The power conversion device according to claim 15, wherein
derivation of the second d-axis current command value and the second q-axis current command value with the current limiting unit is expressed by the following Formula (2):
$$[ Mathematical Formula 2 ]$$
$$( \begin{matrix}{I}_{ref \_ d ( 2 )} \\ {I}_{ref \_ q ( 2 )}\end{matrix} ) = ( \begin{matrix}Max ( Min ( {I}_{ref \_ d ( 1 )} , {I}_{d \_ lím} ) , - {I}_{d \_ lím} ) \\ Max ( Min ( {I}_{ref \_ q ( 1 )} , {I}_{q \_ lím} ) , - {I}_{q \_ lim} )\end{matrix} ) \qquad ( 2 )$$
wherein
Iref_d(2) is the second d-axis current command value,
Iref_q(2) is the second q-axis current command value,
Id_lim is the d-axis current limit value, and
Iq_lim is the q-axis current limit value.

17. The power conversion device according to claim 16, wherein
derivation of the corrected d-axis current command value and the corrected q-axis current command value with the command value inverse transformation unit is expressed by the following Formula (3):
$$[ Mathematical Formula 3 ]$$
$$( \begin{matrix}{I}_{ref \_ d}^{′} \\ {I}_{ref \_ q}^{′}\end{matrix} ) = \frac{1}{\sqrt{{V}_{gd}^{2} + {V}_{gq}^{2}}} ( \begin{matrix}{V}_{gd} & - {V}_{gq} \\ {V}_{gq} & {V}_{gd}\end{matrix} ) ( \begin{matrix}{I}_{ref \_ d ( 2 )} \\ {I}_{ref \_ q ( 2 )}\end{matrix} ) \qquad ( 3 )$$
wherein
I′ref_d is the corrected d-axis current command value, and
I′ref_q is the corrected q-axis current command value.

18. The power conversion device according to claim 2, wherein
the current command value correction unit further includes
an absolute value limiting unit that derives, using a current absolute value limit value input from the outside to the inverter controller to commonly adjust the active power and the reactive power, the second d-axis current command value, and the second q-axis current command value, a third d-axis current command value having the grid phase by multiplying the second d-axis current command value by the current absolute value limit value and derives a third q-axis current command value having the grid phase by multiplying the second q-axis current command value by the current absolute value limit value, and
the command value inverse transformation unit inversely transforms, instead of the second d-axis current command value having the grid phase and the second q-axis current command value having the grid phase, the third d-axis current command value having the grid phase and the third q-axis current command value having the grid phase into the corrected d-axis current command value having the internal phase and the corrected q-axis current command value having the internal phase, respectively.

19. The power conversion device according to claim 16, wherein
the current command value correction unit further includes
an absolute value limiting unit that derives, using a current absolute value limit value input from the outside to the inverter controller to commonly adjust the active power and the reactive power, the second d-axis current command value, and the second q-axis current command value, a third d-axis current command value having the grid phase by multiplying the second d-axis current command value by the current absolute value limit value and derives a third q-axis current command value having the grid phase by multiplying the second q-axis current command value by the current absolute value limit value,
the command value inverse transformation unit inversely transforms, instead of the second d-axis current command value having the grid phase and the second q-axis current command value having the grid phase, the third d-axis current command value having the grid phase and the third q-axis current command value having the grid phase into the corrected d-axis current command value having the internal phase and the corrected q-axis current command value having the internal phase, respectively, and
derivation of the third d-axis current command value and the third q-axis current command value with the absolute value limiting unit is expressed by the following Formula (4), and derivation of the corrected d-axis current command value and the corrected q-axis current command value is expressed by the following Formula (5):
$$[ Mathematical Formula 4 ]$$
$$( \begin{matrix}{I}_{ref \_ d ( 3 )} \\ {I}_{ref \_ q ( 3 )}\end{matrix} ) = \frac{Min ( \sqrt{{( {I}_{ref \_ d ( 2 )} )}^{2} + {( {I}_{ref \_ q ( 2 )} )}^{2} ,} {I}_{abs \_ lim} )}{\sqrt{{( {I}_{ref \_ d ( 2 )} )}^{2} + {( {I}_{ref \_ q ( 2 )} )}^{2}}} ( \begin{matrix}{I}_{ref \_ d ( 2 )} \\ {I}_{ref \_ q ( 2 )}\end{matrix} ) \qquad ( 4 )$$
$$[ Mathematical Formula 5 ]$$
$$( \begin{matrix}{I}_{ref \_ d}^{′} \\ {I}_{ref \_ q}^{′}\end{matrix} ) = \frac{1}{\sqrt{{V}_{gd}^{2} + {V}_{gq}^{2}}} ( \begin{matrix}{V}_{gd} & - {V}_{gq} \\ {V}_{gq} & {V}_{gd}\end{matrix} ) ( \begin{matrix}{I}_{ref \_ d ( 3 )} \\ {I}_{ref \_ q ( 3 )}\end{matrix} ) \qquad ( 5 )$$
wherein
Iref_d(2) is the second d-axis current command value,
Iref_q(2) is the second q-axis current command value,
Iref_d(3) is the third d-axis current command value,
Iref_q(3) is the third q-axis current command value,
Iabs_lim is the current absolute value limit value,
I′ref_d is the corrected d-axis current command value,
I′ref_q is the corrected q-axis current command value,
Vgd is the d-axis voltage, and
Vgq is the q-axis voltage.

20. The power conversion device according to claim 2, wherein the internal phase derivation unit derives the internal frequency deviation by performing predetermined calculation processing using the deviation between the active power and the active power command value and an oscillation equation, derives a rated frequency of the virtual synchronous generator by adding the external frequency command value to the internal frequency deviation, and derives the internal phase by integrating an angular velocity based on the rated frequency of the virtual synchronous generator.

21. The power conversion device according to claim 2, wherein the AVR unit derives the internal voltage by performing predetermined calculation on the deviation between the reactive power and the reactive power command value based on a droop characteristic of AVR to give a first-order lag element to a calculation result, subtracting the output voltage absolute value from a sum of a result of giving the first-order lag element and the external voltage command value, and then performing feedback control.

22. The power conversion device according to claim 2, wherein the internal impedance is virtually simulated based on a winding resistance and a winding reactance of an armature of the virtual synchronous generator.

23. The power conversion device according to claim 2, wherein
the dq transformation unit derives a d-axis inverter current and a q-axis inverter current from an inverter output current measured at a position close to the inverter in the output line of the inverter, and
the switching controller includes:
a current controller that performs current control based on the d-axis inverter current, the q-axis inverter current, the corrected d-axis current command value, and the corrected q-axis current command value to derive a d-axis inverter voltage command value and a q-axis inverter voltage command value;
an inverse dq transformation unit that performs inverse dq transformation on the d-axis inverter voltage command value and the q-axis inverter voltage command value to derive an inverter voltage command value of each phase to be output to the output line of the inverter; and
a PWM unit that generates the switching control signal with PWM control from the inverter voltage command value of each phase.

24. The power conversion device according to claim 2, wherein
the switching controller includes:
a current controller that performs current control based on the d-axis current, the q-axis current, the corrected d-axis current command value, and the corrected q-axis current command value to derive a d-axis voltage command value and a q-axis voltage command value;
an inverse dq transformation unit that performs inverse dq transformation on the d-axis voltage command value and the q-axis voltage command value to derive a voltage command value of each phase to be output to the output line of the inverter; and
a PWM unit that generates the switching control signal with PWM control from the voltage command value of each phase.
